(19) United States
(12) Patent Application Publication
(10) Pub. No.: US 2025/0038791 A1
(43) Pub. Date: Jan. 30, 2025

(54) RECONFIGURABLE INTELLIGENT SURFACE-ASSISTED ACCESS USING UPLINK SIGNATURES

(71) Applicant: QUALCOMM INCORPORATED, San Diego, CA (US)

(72) Inventors: Saeid Sahraei, San Diego, CA (US); Yu Zhang, San Diego, CA (US); Krishna Kiran Mukkavilli, San Diego, CA (US); Peter Gaal, San Diego, CA (US); Wanshi Chen, San Diego, CA (US); Tingfang Ji, San Diego, CA (US); Hung Dinh Ly, San Diego, CA (US)

(21) Appl. No.: 18/716,854

(22) PCT Filed: Feb. 25, 2022
(86) PCT No.: PCT/CN2022/077836

§ 371 Date: Jul. 18, 2024

(51) Int. Cl. H04B 7/04; H04B 7/06; H04L 5/00; H04W 74/0833

(52) U.S. Cl. CPC H04B 7/04013; H04B 7/06952; H04L 5/0048; H04W 74/0833

(57) ABSTRACT

Methods, systems, and devices for wireless communications are described. The method includes a reconfigurable intelligent surface receiving, from a network entity, a synchronization signal block associated with a synchronization signal block index, reflecting the synchronization signal block as a set of multiple instances of the synchronization signal block via a corresponding set of multiple downlink transmit beams, receiving a random access message from a user equipment (UE) during a random access occasion that corresponds with the synchronization signal block index and on an uplink receive beam that corresponds with one of the set of multiple downlink transmit beams, identifying the phase-change pattern of multiple phase-change patterns that corresponds to the uplink receive beam, and reflecting the random access message to the network entity by applying the phase-change pattern to antenna elements of the reconfigurable intelligent surface that reflect the random access message to the network entity.

### CROSS REFERENCE

The present application is a 371 national stage filing of International PCT Application No. PCT/CN2022/077836 by Sahraei et al. entitled “RECONFIGURABLE INTELLIGENT SURFACE-ASSISTED ACCESS USING UPLINK SIGNATURES,” filed Feb. 25, 2022, which is assigned to the assignee hereof, and which is expressly incorporated by reference in its entirety herein.

### FIELD OF TECHNOLOGY

The following relates to wireless communications, including reconfigurable intelligent surface (RIS)-assisted access using uplink signatures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities, base stations, or network access nodes, or any combination thereof, each simultaneously supporting communication for multiple communication devices, which may be otherwise known as user equipment (UE).

In some systems, two or more devices may communicate with each other via a reflective surface. For example, a first device may transmit signaling toward the reflective surface and a second device may receive the signaling reflected off the reflective surface.

### SUMMARY

The described techniques relate to improved methods, systems, devices, and apparatuses that support reconfigurable intelligent surface (RIS)-assisted access using uplink signatures. Generally, the described techniques provide for enabling a RIS to add a phase-change watermark to uplink transmissions. In some cases, a network entity may transmit an indexed synchronization signal block to the RIS. The RIS may reflect instances of the synchronization signal block (e.g., each synchronization signal block being associated with the same index) in downlink transmit beams that the RIS directs in multiple directions. A user equipment (UE) may receive a synchronization signal block reflected by the RIS, and may transmit a random access message to the RIS based on the received synchronization signal block. The RIS may identify a phase-change pattern associated with the received random access message and reflect the random access message to the network entity by applying the identified phase-change pattern to antenna elements of the RIS. The network entity may determine an uplink receive beam used by the RIS to receive the random access message from the UE based on the phase-change pattern, enabling the network entity to communicate with the UE via the RIS using the uplink receive beam and a corresponding downlink transmit beam.

A method for wireless communication at a reconfigurable intelligent surface is described. The method may include receiving, from a network entity, a synchronization signal block associated with a synchronization signal block index, reflecting the synchronization signal block as a set of multiple instances of the synchronization signal block via a corresponding set of multiple downlink transmit beams, receiving a random access message from a user equipment (UE) during a random access occasion that corresponds with the synchronization signal block index and on an uplink receive beam that corresponds with one of the set of multiple downlink transmit beams, identifying a phase-change pattern that corresponds to the uplink receive beam, and reflecting the random access message to the network entity by applying the phase-change pattern to antenna elements of the reconfigurable intelligent surface.

An apparatus for wireless communication at a reconfigurable intelligent surface is described. The apparatus may include a processor, memory coupled with the processor, and instructions stored in the memory. The instructions may be executable by the processor to cause the apparatus to receive, from a network entity, a synchronization signal block associated with a synchronization signal block index, reflect the synchronization signal block as a set of multiple instances of the synchronization signal block via a corresponding set of multiple downlink transmit beams, receive a random access message from a UE during a random access occasion that corresponds with the synchronization signal block index and on an uplink receive beam that corresponds with one of the set of multiple downlink transmit beams, identify a phase-change pattern that corresponds to the uplink receive beam, and reflect the random access message to the network entity by applying the phase-change pattern to antenna elements of the reconfigurable intelligent surface.

Another apparatus for wireless communication at a reconfigurable intelligent surface is described. The apparatus may include means for receiving, from a network entity, a synchronization signal block associated with a synchronization signal block index, means for reflecting the synchronization signal block as a set of multiple instances of the synchronization signal block via a corresponding set of multiple downlink transmit beams, means for receiving a random access message from a UE during a random access occasion that corresponds with the synchronization signal block index and on an uplink receive beam that corresponds with one of the set of multiple downlink transmit beams, means for identifying a phase-change pattern that corresponds to the uplink receive beam, and means for reflecting the random access message to the network entity by applying the phase-change pattern to antenna elements of the reconfigurable intelligent surface.

A non-transitory computer-readable medium storing code for wireless communication at a reconfigurable intelligent surface is described. The code may include instructions executable by a processor to receive, from a network entity, a synchronization signal block associated with a synchronization signal block index, reflect the synchronization signal block as a set of multiple instances of the synchronization signal block via a corresponding set of multiple downlink transmit beams, receive a random access message from a UE during a random access occasion that corresponds with the synchronization signal block index and on an uplink receive beam that corresponds with one of the set of multiple downlink transmit beams, identify a phase-change pattern that corresponds to the uplink receive beam, and reflect the random access message to the network entity by applying the phase-change pattern to antenna elements of the reconfigurable intelligent surface.

In some examples of the method, apparatuses, and non-transitory computer-readable medium described herein, receiving the random access message from the UE during the random access occasion and on the uplink receive beam may include operations, features, means, or instructions for sweeping through a set of multiple uplink receive beams, the uplink receive beam on which the random access message may be received being one of the set of multiple uplink receive beams.

Some examples of the method, apparatuses, and non-transitory computer-readable medium described herein may further include operations, features, means, or instructions for identifying a set of multiple phase-change patterns corresponding to the set of multiple uplink receive beams, the phase-change pattern identified as corresponding to the uplink receive beam on which the random access message may be received being one of the set of multiple phase-change patterns.

In some examples of the method, apparatuses, and non-transitory computer-readable medium described herein, identifying the set of multiple phase-change patterns may include operations, features, means, or instructions for determining a number of the set of multiple phase-change patterns, the number of the set of multiple phase-change patterns based on a number of beams supported by the reconfigurable intelligent surface.

In some examples of the method, apparatuses, and non-transitory computer-readable medium described herein, identifying the set of multiple phase-change patterns may include operations, features, means, or instructions for determining the set of multiple phase-change patterns based on a Hadamard matrix whose size may be based on a number of beams supported by the reconfigurable intelligent surface.

In some examples of the method, apparatuses, and non-transitory computer-readable medium described herein, the set of multiple phase-change patterns may be a set of multiple time-domain orthogonal cover codes.

In some examples of the method, apparatuses, and non-transitory computer-readable medium described herein, each of the set of multiple phase-change patterns may be unique from others of the set of multiple phase-change patterns based on a timing of phase-changes applied to the antenna elements of the reconfigurable intelligent surface.

In some examples of the method, apparatuses, and non-transitory computer-readable medium described herein, reflecting the synchronization signal block may include operations, features, means, or instructions for reflecting each instance of the synchronization signal block during a respective portion of a transmission time interval associated with transmission by the network entity of the synchronization signal block, the set of multiple the instances of the synchronization signal block being reflected during the transmission time interval.

In some examples of the method, apparatuses, and non-transitory computer-readable medium described herein, each of the set of multiple instances of the synchronization signal block corresponds to a same synchronization signal block index.

A method for wireless communication at a network entity is described. The method may include transmitting, via a reconfigurable intelligent surface, a synchronization signal block associated with a synchronization signal block index, receiving a random access message from a UE during a random access occasion that corresponds with the synchronization signal block index, identifying a phase-change pattern of the random access message received at the network entity, the phase-change pattern being one of a set of multiple phase-change patterns corresponding to different uplink receive beams used by the reconfigurable intelligent surface, determining an uplink receive beam used by the reconfigurable intelligent surface to receive the random access message from the UE based on the phase-change pattern, and communicating with the UE via the reconfigurable intelligent surface using the uplink receive beam and a corresponding downlink transmit beam of the reconfigurable intelligent surface.

An apparatus for wireless communication at a network entity is described. The apparatus may include a processor, memory coupled with the processor, and instructions stored in the memory. The instructions may be executable by the processor to cause the apparatus to transmit, via a reconfigurable intelligent surface, a synchronization signal block associated with a synchronization signal block index, receive a random access message from a UE during a random access occasion that corresponds with the synchronization signal block index, identify a phase-change pattern of the random access message received at the network entity, the phase-change pattern being one of a set of multiple phase-change patterns corresponding to different uplink receive beams used by the reconfigurable intelligent surface, determine an uplink receive beam used by the reconfigurable intelligent surface to receive the random access message from the UE based on the phase-change pattern, and communicate with the UE via the reconfigurable intelligent surface using the uplink receive beam and a corresponding downlink transmit beam of the reconfigurable intelligent surface.

Another apparatus for wireless communication at a network entity is described. The apparatus may include means for transmitting, via a reconfigurable intelligent surface, a synchronization signal block associated with a synchronization signal block index, means for receiving a random access message from a UE during a random access occasion that corresponds with the synchronization signal block index, means for identifying a phase-change pattern of the random access message received at the network entity, the phase-change pattern being one of a set of multiple phase-change patterns corresponding to different uplink receive beams used by the reconfigurable intelligent surface, means for determining an uplink receive beam used by the reconfigurable intelligent surface to receive the random access message from the UE based on the phase-change pattern, and means for communicating with the UE via the reconfigurable intelligent surface using the uplink receive beam and a corresponding downlink transmit beam of the reconfigurable intelligent surface.

A non-transitory computer-readable medium storing code for wireless communication at a network entity is described. The code may include instructions executable by a processor to transmit, via a reconfigurable intelligent surface, a synchronization signal block associated with a synchronization signal block index, receive a random access message from a UE during a random access occasion that corresponds with the synchronization signal block index, identify a phase-change pattern of the random access message received at the network entity, the phase-change pattern being one of a set of multiple phase-change patterns corresponding to different uplink receive beams used by the reconfigurable intelligent surface, determine an uplink receive beam used by the reconfigurable intelligent surface to receive the random access message from the UE based on the phase-change pattern, and communicate with the UE via the reconfigurable intelligent surface using the uplink receive beam and a corresponding downlink transmit beam of the reconfigurable intelligent surface.

Some examples of the method, apparatuses, and non-transitory computer-readable medium described herein may further include operations, features, means, or instructions for determining a number of the set of multiple phase-change patterns, the number of the set of multiple phase-change patterns based on a number of beams supported by the reconfigurable intelligent surface.

Some examples of the method, apparatuses, and non-transitory computer-readable medium described herein may further include operations, features, means, or instructions for determining the set of multiple phase-change patterns based on a Hadamard matrix whose size may be based on a number of beams supported by the reconfigurable intelligent surface.

In some examples of the method, apparatuses, and non-transitory computer-readable medium described herein, the set of multiple phase-change patterns may be a set of multiple time-domain orthogonal cover codes.

In some examples of the method, apparatuses, and non-transitory computer-readable medium described herein, each of the set of multiple phase-change patterns may be unique from others of the set of multiple phase-change patterns based on a timing of phase-changes applied to antenna elements of the reconfigurable intelligent surface.

Some examples of the method, apparatuses, and non-transitory computer-readable medium described herein may further include operations, features, means, or instructions for identifying a set of cyclic shifts that may be permissible for use with random access message transmission, where the set of cyclic shifts may be based on the reconfigurable intelligent surface applying the phase-change pattern to uplink communications.

Some examples of the method, apparatuses, and non-transitory computer-readable medium described herein may further include operations, features, means, or instructions for transmitting a configuration message that includes a correction term to be used by the UE in selecting the set of cyclic shifts when the reconfigurable intelligent surface may be applying the phase-change pattern to the uplink communications, where the correction term represents a number of cyclic shifts offset.

In some examples of the method, apparatuses, and non-transitory computer-readable medium described herein, a value of the correction term may be based on a number of beams associated with the reconfigurable intelligent surface.

Some examples of the method, apparatuses, and non-transitory computer-readable medium described herein may further include operations, features, means, or instructions for transmitting an indication that the correction term may be to be applied by the UE in selecting the set of cyclic shifts.

In some examples of the method, apparatuses, and non-transitory computer-readable medium described herein, the indication may be a one-bit field included in either a medium access control (MAC) control element (CE) or a downlink control information (DCI) message.

In some examples of the method, apparatuses, and non-transitory computer-readable medium described herein, the indication further indicates a mapping between zero correlation zone configuration and the set of cyclic shifts.

In some examples of the method, apparatuses, and non-transitory computer-readable medium described herein, the configuration message may be a radio resource control message.

A method for wireless communication at a UE is described. The method may include receiving a message at the UE that is indicative that uplink communications between the UE and a network entity are via a reconfigurable intelligent surface that is applying a phase-change pattern to the uplink communications to distinguish between beams used by the reconfigurable intelligent surface for the uplink communications, receiving a synchronization signal block from the network entity during a portion of a transmission time interval associated with transmission by the network entity of the synchronization signal block, the synchronization signal block being received as one of a set of multiple instances of the synchronization signal block reflected by the reconfigurable intelligent surface, where each of the set of multiple instances of the synchronization signal block corresponds to a same synchronization signal block index, and transmitting a random access message during a random access occasion that corresponds to the synchronization signal block index.

An apparatus for wireless communication at a UE is described. The apparatus may include a processor, memory coupled with the processor, and instructions stored in the memory. The instructions may be executable by the processor to cause the apparatus to receive a message at the UE that is indicative that uplink communications between the UE and a network entity are via a reconfigurable intelligent surface that is applying a phase-change pattern to the uplink communications to distinguish between beams used by the reconfigurable intelligent surface for the uplink communications, receive a synchronization signal block from the network entity during a portion of a transmission time interval associated with transmission by the network entity of the synchronization signal block, the synchronization signal block being received as one of a set of multiple instances of the synchronization signal block reflected by the reconfigurable intelligent surface, where each of the set of multiple instances of the synchronization signal block corresponds to a same synchronization signal block index, and transmit a random access message during a random access occasion that corresponds to the synchronization signal block index.

Another apparatus for wireless communication at a UE is described. The apparatus may include means for receiving a message at the UE that is indicative that uplink communications between the UE and a network entity are via a reconfigurable intelligent surface that is applying a phase-change pattern to the uplink communications to distinguish between beams used by the reconfigurable intelligent surface for the uplink communications, means for receiving a synchronization signal block from the network entity during a portion of a transmission time interval associated with transmission by the network entity of the synchronization signal block, the synchronization signal block being received as one of a set of multiple instances of the synchronization signal block reflected by the reconfigurable intelligent surface, where each of the set of multiple instances of the synchronization signal block corresponds to a same synchronization signal block index, and means for transmitting a random access message during a random access occasion that corresponds to the synchronization signal block index.

A non-transitory computer-readable medium storing code for wireless communication at a UE is described. The code may include instructions executable by a processor to receive a message at the UE that is indicative that uplink communications between the UE and a network entity are via a reconfigurable intelligent surface that is applying a phase-change pattern to the uplink communications to distinguish between beams used by the reconfigurable intelligent surface for the uplink communications, receive a synchronization signal block from the network entity during a portion of a transmission time interval associated with transmission by the network entity of the synchronization signal block, the synchronization signal block being received as one of a set of multiple instances of the synchronization signal block reflected by the reconfigurable intelligent surface, where each of the set of multiple instances of the synchronization signal block corresponds to a same synchronization signal block index, and transmit a random access message during a random access occasion that corresponds to the synchronization signal block index.

Some examples of the method, apparatuses, and non-transitory computer-readable medium described herein may further include operations, features, means, or instructions for selecting a set of cyclic shifts that may be permissible for application to transmission of the random access message, where selection of the set of cyclic shifts may be based on the reconfigurable intelligent surface applying the phase-change pattern to the uplink communications.

In some examples of the method, apparatuses, and non-transitory computer-readable medium described herein, selecting the set of cyclic shifts may include operations, features, means, or instructions for receiving a configuration message that includes a correction term to be used in selecting the set of cyclic shifts when the reconfigurable intelligent surface may be applying the phase-change pattern to the uplink communications, where the correction term represents a number of cyclic shifts offset.

In some examples of the method, apparatuses, and non-transitory computer-readable medium described herein, a value of the correction term may be based on a number of beams associated with the reconfigurable intelligent surface.

In some examples of the method, apparatuses, and non-transitory computer-readable medium described herein, selecting the set of cyclic shifts may include operations, features, means, or instructions for receiving an indication that the correction term may be to be applied in selecting the set of cyclic shifts.

In some examples of the method, apparatuses, and non-transitory computer-readable medium described herein, the indication may be a one-bit field included in either a medium access control (MAC) control element (CE) or a DCI message.

In some examples of the method, apparatuses, and non-transitory computer-readable medium described herein, the indication further indicates a mapping between zero correlation zone configuration and the set of cyclic shifts.

In some examples of the method, apparatuses, and non-transitory computer-readable medium described herein, the configuration message may be a radio resource control message.

### BRIEF DESCRIPTION OF THE DRAWINGS

FIGS. 1 and 2 illustrate examples of wireless communications systems that supports reconfigurable intelligent surface (RIS)-assisted access using uplink signatures in accordance with aspects of the present disclosure.

FIG. 3 illustrates an example of an uplink signature procedure that supports RIS-assisted access using uplink signatures in accordance with aspects of the present disclosure.

FIG. 4 illustrates an example of an uplink watermarking that supports RIS-assisted access using uplink signatures in accordance with aspects of the present disclosure.

FIG. 5 illustrates an example of a process flow that supports RIS-assisted access using uplink signatures in accordance with aspects of the present disclosure.

FIGS. 6 and 7 show block diagrams of devices that support RIS-assisted access using uplink signatures in accordance with aspects of the present disclosure.

FIG. 8 shows a block diagram of a communications manager that supports RIS-assisted access using uplink signatures in accordance with aspects of the present disclosure.

FIG. 9 shows a diagram of a system including a device that supports RIS-assisted access using uplink signatures in accordance with aspects of the present disclosure.

FIGS. 10 and 11 show block diagrams of devices that support RIS-assisted access using uplink signatures in accordance with aspects of the present disclosure.

FIG. 12 shows a block diagram of a communications manager that supports RIS-assisted access using uplink signatures in accordance with aspects of the present disclosure.

FIG. 13 shows a diagram of a system including a device that supports RIS-assisted access using uplink signatures in accordance with aspects of the present disclosure.

FIGS. 14 and 15 show block diagrams of devices that support RIS-assisted access using uplink signatures in accordance with aspects of the present disclosure.

FIG. 16 shows a block diagram of a communications manager that supports RIS-assisted access using uplink signatures in accordance with aspects of the present disclosure.

FIG. 17 shows a diagram of a system including a device that supports RIS-assisted access using uplink signatures in accordance with aspects of the present disclosure.

FIGS. 18 through 20 show flowcharts illustrating methods that support RIS-assisted access using uplink signatures in accordance with aspects of the present disclosure.

### DETAILED DESCRIPTION

The present techniques include methods for reconfigurable intelligent surface (RIS)-assisted initial access via uplink watermarking on random access channel messages. In some cases, a network entity may transmit synchronization signal blocks (SSBs) in different directions via a beam sweep. A user equipment (UE) looking to connect with the network of the network entity may receive one the SSBs (e.g., transmitted in a direction that aligns to some degree with the UE). The UE may respond by sending a random access channel (RACH) message to the network entity using resources that correspond to an index of the received SSB. However, in some cases, the communication path between the UE and network entity may be blocked. In some cases, a RIS may be used to reflect the communications between the network entity and UE. During the SSB beam sweep, the RIS may perform a beam sweep (e.g., based on the beam sweep of the network entity), and the UE may determine a best RIS transmit beam (e.g., for subsequent communications with the network entity). However, beam sweeping by the RIS of different SSBs may add a relatively large amount of time to the SSB beam sweep process. For example, a network entity may repeatedly transmit an SSB to the RIS in a given direction to enable the RIS to sweep, one-by-one, through its transmit beams at a rate of one beam per SSB transmission. With an increasing number of beams to sweep, this option may not be sustainable in some systems.

In some systems, a RIS may be configured to sweep through its transmit beams at a relatively fast rate so that the full RIS beam sweep occurs during a single instance of an SSB transmission from the network entity. However, since the beam sweep at the RIS occurs for only a single SSB transmission (e.g., having a single SSB index), in such a system a RACH message by the UE may be received at the network entity on the same resources regardless of which RIS beam is used by the UE, resulting in the network entity may not being capable of determining the best RIS beam for communications with the UE.

The described techniques include enabling the RIS to add a phase-change watermark to its uplink transmissions to enable the network entity to determine the best RIS beam for communication with the UE. In some cases, the network entity and the RIS may be configured to generate or recognize one or more watermarking patterns (e.g., one unique watermarking pattern per uplink RIS beam). In some cases, the network entity may inform the UE when RIS uplink watermarking is being implemented. When the network entity identifies a watermarking pattern in an uplink transmission, the network entity may determine which uplink RIS beam is associated with that uplink transmission based on the identified watermarking pattern. In some cases, the watermarking pattern may be a phase-change pattern applied by the RIS. One issue that may arise is that the watermarking pattern may be applied with durations that impact which sets of cyclic shifts a UE may use in transmitting its RACH message. To remedy this issue, the network entity may provide a cyclic shift correction term to enable the UE to select a proper range of cyclic shifts.

Aspects of the subject matter described herein may be implemented to realize one or more advantages. The described techniques may support improvements in system efficiency such that a device may improve one or more aspects of communication (e.g., increased signal quality, increased throughput, increased transmission efficiency, increased power savings, etc.) between a UE, a RIS, and network entity, such as when an object blocks or otherwise inhibits a line-of-sight (LoS) link between the network entity and the UE. Additionally, described techniques may result in avoiding multiple retransmissions and failed transmissions, decreasing system latency, improving the reliability of transmissions between the UE and the network entity, and improving user experience.

Aspects of the disclosure are initially described in the context of wireless communications systems. Aspects of the disclosure are further illustrated by and described with reference to an uplink signature procedures, including time-domain orthogonal cover code, that relate to reconfigurable intelligent surface-assisted access using uplink signatures. Aspects of the disclosure are further illustrated by and described with reference to apparatus diagrams, system diagrams, and flowcharts that relate to uplink signatures with reconfigurable intelligent surfaces.

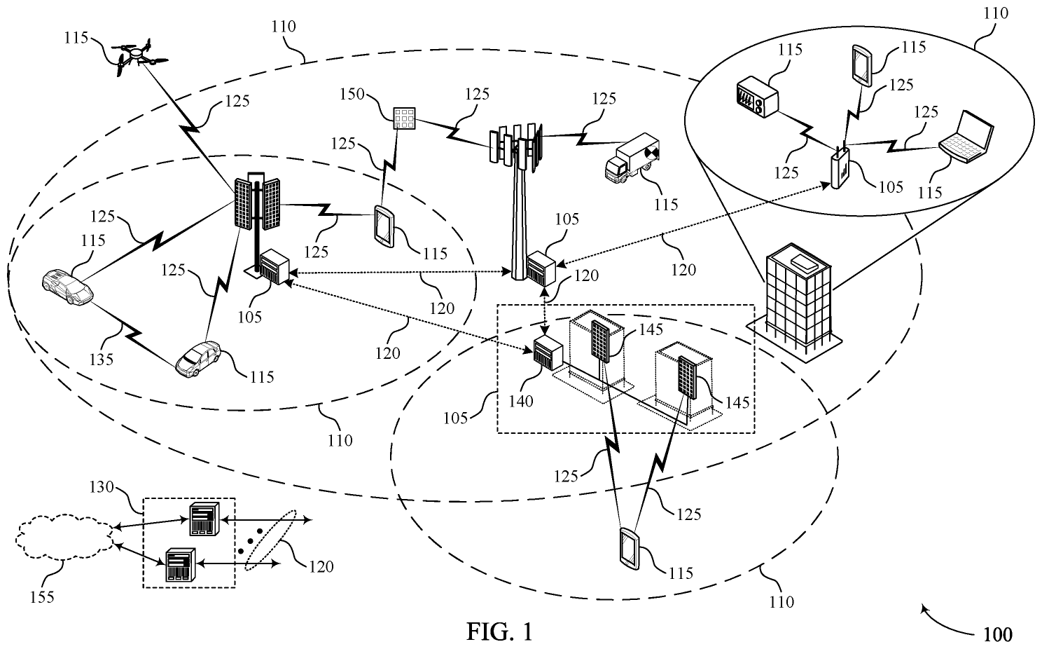

FIG. 1 illustrates an example of a wireless communications system 100 that supports RIS-assisted access using uplink signatures in accordance with aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The network entities 105 may be dispersed throughout a geographic area to form the wireless communications system 100 and may be devices in different forms or having different capabilities. The network entities 105 and the UEs 115 may wirelessly communicate via one or more communication links 125. Each network entity 105 may provide a coverage area 110 over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network entities 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, network entity 105, entity of a core network 130, apparatus, device, or computing system configured to perform any techniques described herein. For example, a network node may be a UE 115. As another example, a network node may be a network entity 105. As another example, a first network node may be configured to communicate with a second network node or a third network node. In one aspect of this example, the first network node may be a UE 115, the second network node may be a network entity 105, and the third network node may be a UE 115. In another aspect of this example, the first network node may be a UE 115, the second network node may be a network entity 105, and the third network node may be a network entity 105. In yet other aspects of this example, the first, second, and third network nodes may be different. Similarly, reference to a UE 115, a network entity 105, an apparatus, a device, or a computing system may include disclosure of the UE 115, network entity 105, apparatus, device, or computing system being a network node. For example, disclosure that a UE 115 is configured to receive information from a network entity 105 also discloses that a first network node is configured to receive information from a second network node. In this example, consistent with this disclosure, the first network node may refer to a first UE 115, a first network entity 105, a first apparatus, a first device, or a first computing system configured to receive the information; and the second network node may refer to a second UE 115, a second network entity 105, a second apparatus, a second device, or a second computing system.

The network entities 105 may communicate with the core network 130, or with one another, or both. For example, the network entities 105 may interface with the core network 130 through one or more backhaul links 120 (e.g., via an S1, N2, N3, or other interface). The network entities 105 may communicate with one another over the backhaul links 120 (e.g., via an X2, Xn, or other interface) either directly (e.g., directly between network entities 105), or indirectly (e.g., via core network 130), or both. In some examples, the backhaul links 120 may be or include one or more wireless links.

One or more of the network entities 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

One or more of the network entities 105 described herein may include or may be referred to as a base station (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station) may be implemented in an aggregated (e.g., monolithic, standalone) base station architecture, which may be configured to utilize a protocol stack that is physically or logically integrated within a single network entity 105 (e.g., a single RAN node, such as a base station).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof. An RU may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU, a DU, and an RU is flexible and may support different functionalities depending upon which functions (e.g., network layer functions, protocol layer functions, baseband functions, RF functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some examples, the CU may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU. Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some cases, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU). A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some examples, a midhaul communication link or a fronthaul communication link may be implemented in accordance with an interface (e.g., a channel) between layers of a protocol stack supported by respective network entities 105 that are in communication over such communication links.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entities 105. The wireless communications system 100 may include, for example, a heterogeneous network in which different types of the network entities 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 associated with the core network 130. User IP packets may be transferred through the user plane entity, which may provide IP address allocation as well as other functions. The user plane entity may be connected to IP services 155 for one or more network operators. The IP services 155 may include access to the Internet, Intranet(s), an IP Multimedia Subsystem (IMS), or a Packet-Switched Streaming Service.

Some of the network devices, such as a network entity 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or network entity 105 may be distributed across various network devices (e.g., radio heads and ANCs) or consolidated into a single network device (e.g., a network entity 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more network entity antennas or antenna arrays may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna array's that may support various MIMO or beamforming operations. Additionally or alternatively, an antenna panel may support radio frequency beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times in different directions. For example, the network entity 105 may transmit a signal according to different beamforming weight sets associated with different directions of transmission. Transmissions in different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a network entity 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the network entity 105 in different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured number of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a network entity 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the network entity 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a network entity 105 or a core network 130 supporting radio bearers for user plane data. At the physical layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some deployment scenarios, direct beamforming between two devices (e.g., a UE 115 and network entity 105 of FIG. 1) may be insufficient and fail to support a reliable communication link between the two devices. In some of such deployment scenarios, the two devices may use an assisting device, such as a reconfigurable intelligent surface (RIS) 150, to support the communication link between the devices. In some cases, the RIS 150, which may be an example of a reflective surface, may be associated with a number of different configurations, where each of the different configurations corresponds to a unique pair of a receive beam at the RIS 150 and a reflected beam from the RIS 150.

To support an uplink signature procedure between two devices, such as between a network entity 105 and a UE 115, the RIS 150 may be divided into a number of sub-RISs, each sub-RIS configured to have a common receive beam oriented toward the network entity 105 and different reflected beams oriented toward potential locations of the UE 115. As part of the uplink signature procedure, the network entity 105 may transmit an SSB for each of a number of SSB beams and at least one of the SSBs may hit the surface of the RIS 150. The RIS 150 may reflect the SSB via a number of different reflected beams in accordance with the configurations of the sub-RISs and, in some scenarios, at least one of the reflected beams may reach the UE 115.

Generally, the described techniques provide for enabling RIS 150 to add a phase-change watermark to uplink transmissions from the UE 115 to the network entity 105. In some cases, the network entity 105 may transmit, an indexed synchronization signal block to the RIS 150. The RIS 150 may reflect instances of the synchronization signal block (e.g., each synchronization signal block being associated with the same index) in downlink transmit beams that the RIS 150 directs in multiple directions. In some cases, the UE 115 may receive a synchronization signal block (e.g., at least one instance of the synchronization signal blocks) reflected by the RIS 150, and may transmit a random access message to the RIS 150 based on the received synchronization signal block (e.g., based on the instance of the synchronization signal blocks with the highest measured signal strength as determined by the UE 115). The RIS 150 may receive the synchronization signal block from the UE 115 and identify a phase-change pattern that corresponds to the uplink receive beam. In some cases, the RIS 150 may reflect the random access message to the network entity 105 by applying the identified phase-change pattern to antenna elements of the RIS 150. In some examples, the network entity 105 may receive the reflected random access message and identify the phase-change pattern. The network entity 105 may determine the uplink receive beam used by the RIS 150 to receive the random access message from the UE 115 based on the identified phase-change pattern. The network entity 105 may communicate with the UE 115 via the RIS 150 using the uplink receive beam and a corresponding downlink transmit beam of the RIS 150.

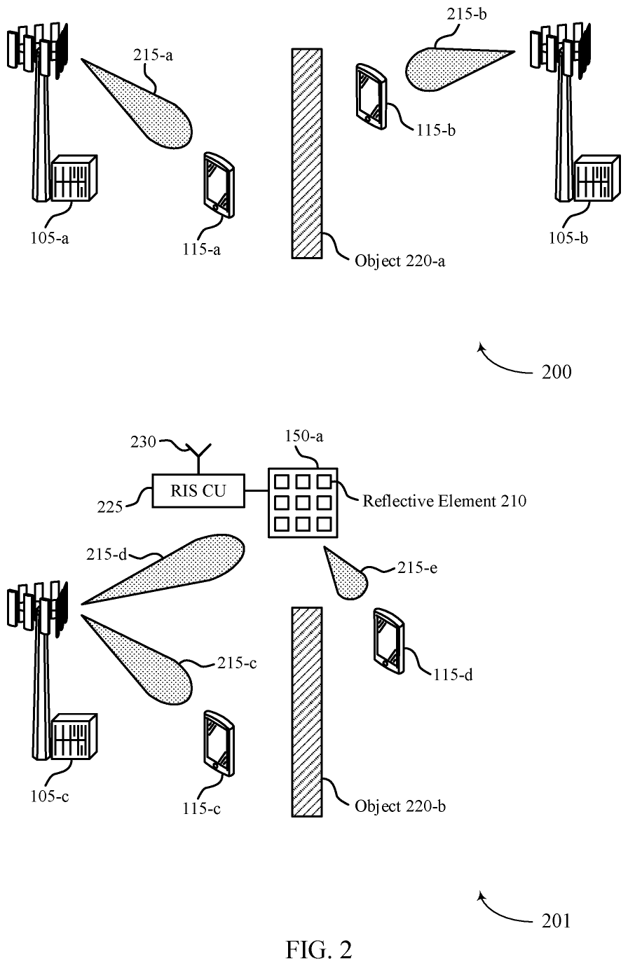

FIG. 2 illustrates an example of a wireless communications systems 200 and 201 that supports RIS-assisted access using uplink signatures in accordance with aspects of the present disclosure. The wireless communications systems 200 and 201 may implement or be implemented to realize aspects of the wireless communications system 100. For example, the wireless communications systems 200 and 201 both illustrate communication between one or more UEs 115 and one or more network entities 105, which may be examples of corresponding devices described herein, including with reference to FIG. 1. In some implementations, a UE 115 and a network entity 105 may participate in an uplink signature procedure involving a RIS 150 in accordance with the examples disclosed herein.

Some systems may employ massive MIMO (such as 5G massive MIMO) to increase an achievable throughput between two communicating devices, and such systems may extend coverage via one or more active antenna units or one or more passive reflective surfaces (such as RISs), or any combination thereof. For example, and as illustrated by the wireless communications system 200 in which a network entity 105-a transmits to a UE 115-a via a beam 215-a and a network entity 105-b transmits to a UE 115-b via a beam 215-b, some systems may achieve a relatively higher beamforming gain by using active antenna units. In some aspects, such active antenna units may be associated with a use of individual radio frequency chains per antenna ports. Such systems may experience a significant increase in power consumption due to the use of active antenna units.

For example, the wireless communications system 200 may include an object 220-a that blocks or otherwise inhibits a line-of-sight (LoS) link between the network entity 105-a and the UE 115-b. As such, the wireless communications system 200 may include the network entity 105-b, supporting an active antenna unit, to support wireless communications with the UE 115-b (as the network entity 105-a may be unable to support wireless communications with the UE 115-b due to a location of the object 220-a and a location of the UE 115-b). Thus, to support wireless communications with both the UE 115-a and the UE 115-b, the wireless communications system 200 may deploy two network entities 105 each operating separate active antenna units, which may be associated with an increase in power consumption. Further, although illustrated to show two network entities 105, the wireless communications system 200 may additionally or alternatively deploy one or more other devices capable of supporting an active antenna unit, such as a relay node or a smart repeater, to support wireless communications with both the UE 115-a and the UE 115-b.

Some systems (such as the wireless communications system 201) may, in addition or as an alternative to deploying additional active antenna units, employ the use of one or more assisting devices, such as one or more RISs 150, to extend coverage (such as 5G coverage) with a negligible or relatively small increase in power consumption. In other words, some systems (e.g., including the wireless communications system 201) may leverage passive MIMO as a substitute for an active antenna unit. For example, the RIS 150-a may be a near-passive device capable of reflecting an impinging or incident wave to a desired location or in a desired direction.

As illustrated in the wireless communications system 201, for example, a network entity 105-c may use the RIS 150-a to reflect communications from the network entity 105-c via a beam 215-d (directed to the RIS 150-a) to a UE 115-d via a beam 215-e (directed from the RIS 150-a to the UE 115) to avoid an object 220-b. As such, the network entity 105-c (e.g., a single network entity 105 operating an active antenna unit) may communicate (directly) with a UE 115-c via a beam 215-c and may communicate (indirectly, due to a location of the object 220-b and the UE 115-d) with the UE 115-d via the RIS 150-a. A node or centralized unit (CU), such as a RIS CU 225, may configure a reflection characteristic of the RIS 150-a to control the reflection direction from the RIS 150-a and, in some aspects, a network entity 105 may configure or control the node or CU (such that the network entity 105 may effectively configure or control the reflection direction of the RIS 150-a). In some examples, a network entity 105-c may transmit messaging to the RIS CU 225 indicating a configuration of the RIS 150-a and the RIS CU 225 may configure the RIS 150-a accordingly. In some aspects, a configuration of the RIS 150-a may be associated with a receive beam, such as a directional beam or configuration for directional “reception” of signaling, and a reflected beam, such a directional beam or configuration for directional reflection of the signaling. Further, although described herein as a “receive” beam, a receive beam associated with a configuration of the RIS 150-a may refer to reception as part of a reflecting (as opposed to, for example, as part of a decoding).

The RIS 150-a may function similarly to a mirror or other reflective surface in its ability to reflect incident beams or waves (such as light waves), but may differ in that the RIS 150-a may include one or more components that are able to control or dictate how an incident beam or wave is reflected (such that an angle of incidence can be different than an angle of reflection) or that are able to control or dictate a shape of a reflected beam or wave (such as via energy focusing or energy nulling via constructive interference or destructive interference, respectively), or both. For example, the RIS 150-a may include a quantity of reflective elements 210 that each have a controllable delay, phase, or polarization, or any combination thereof, and the RIS CU 225 may control or configure each of the reflective elements 210 to control how an incident beam or wave is reflected or to control a shape of a reflected beam or wave. The RIS 150-a may be an example of or may otherwise be referred to as a software-controlled metasurface, a configurable reflective surface, a reflective intelligent surface, or a configurable intelligent surface, and may sometimes be a metal surface (such as a copper surface) including a quantity of reflective elements 210. In some aspects, a RIS CU 225 may be coupled with the RIS 150-a via hardware (such as via a fiber optic cable). In some other aspects, a RIS CU 225 may be non-co-located with the RIS 150-a and may configure the RIS 150-a via over-the-air signaling.

In some aspects, the RIS CU 225 may have both transmission and reception capability via one or more antennas 230. The RIS CU 225 may use its transmission and reception capability to assist in establishing an RRC connection between the network entity 105-c and the RIS CU 225. For example, the network entity 105-c may sweep over a set of SSB beams and the RIS CU 225 may measure each of the set of SSB beams and respond with a RACH preamble corresponding to a strongest of the set of SSB beams. As such, the network entity 105-c may learn (based on receiving the RACH preamble response from the RIS CU 225) which beam to use to communicate with the RIS CU 225. The network entity 105-c may use the same beam to transmit signaling to the RIS 150-a (such as to “light up” a surface of the RIS 150-a), which may support or otherwise facilitate a configuration of the RIS 150-a, by the network entity 105-c, such that a receive beam of the RIS 150-a is oriented toward the network entity 105-c.

In accordance with the implementations described herein, the network entity 105-c may attempt an uplink signature procedure with the UE 115-d via the RIS 150-a. For example, the network entity 105-c may transmit an SSB using each of a set of beams (such as SSB beams) and at least one of the beams may be oriented toward the RIS 150-a. As such, the RIS 150-a may reflect an SSB via one or more reflected beams in accordance with a configuration of the RIS 150-a. In some aspects, the network entity 105 may configure the RIS 150-a such that the RIS 150-a includes or otherwise supports a number of sub-RISs, each sub-RIS associated with a respective configuration (e.g., a respective reflected beam toward potential or candidate locations of the UE 115-d). In some implementations, the UE 115-d, the RIS 150-a, or the network entity 105-c, or any combination thereof, may support one or more signaling- or configuration-based mechanisms to facilitate an obtaining of feedback as to which sub-RIS of the RIS 150-a is able to reflect signaling (e.g., an SSB) to the UE 115-d. In some aspects, the one or more signaling- or configuration-based mechanisms may be associated with or otherwise involve the use of random access signaling between the UE 115-d and the network entity 105-c.

The techniques described herein may reduce power consumption and free up processing cycles of one or more devices (e.g., battery-operated devices, a UE 115, etc.) by enabling a RIS 150 to add a phase-change watermark to uplink transmissions to enable a network entity 105 to determine the best sub-RIS beam for communication between the network entity 105, the RIS 150, and the UE 115. Using the best sub-RIS beam for communication results in the UE 115 use less power to transmit a signal to the network entity 105 via RIS 150, thus reducing the power the UE 115 uses to communicate with the network entity 105 and increasing the battery life of the UE 115.

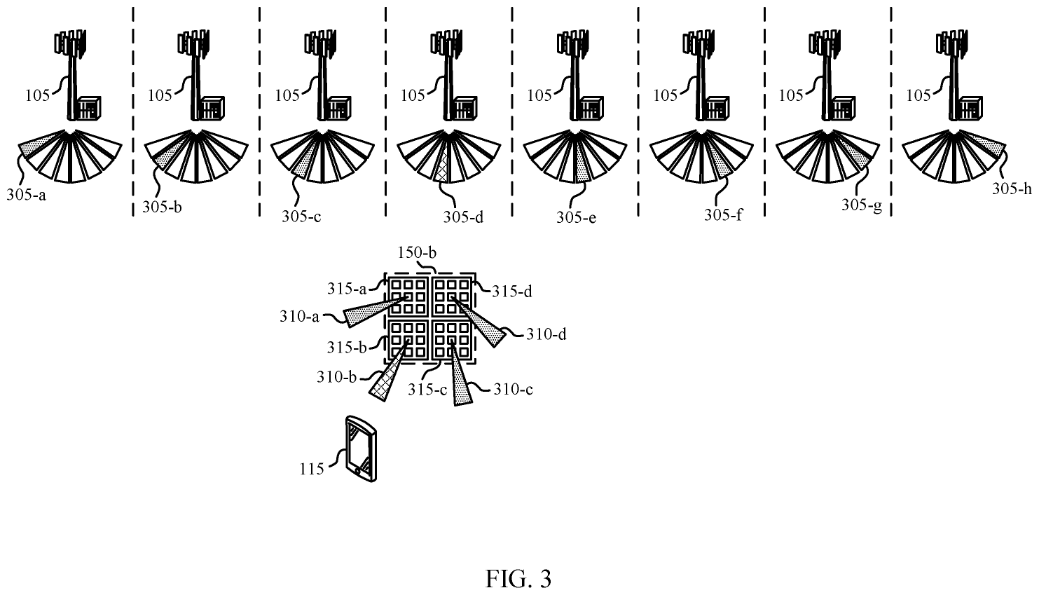

FIG. 3 illustrates an example of an uplink signature procedure 300 that supports RIS-assisted access using uplink signatures in accordance with aspects of the present disclosure. The uplink signature procedure 300 may implement or be implemented to realize aspects of the wireless communications system 100, the wireless communications system 200, or the wireless communications system 201. For example, the uplink signature procedure 300 illustrates a beam planning between a network entity 105 and a UE 115 via a RIS 150, which may be examples of corresponding devices described herein, including with reference to FIGS. 1 and 2.

As part of the uplink signature procedure 300, the network entity 105 may transmit one or more reference signals, such as one or more SSBs, via each of a set of beams 305 (which may be examples of SSB beams). The network entity 105 may transmit an SSB via a different beam 305 during each of a set of occasions associated with the uplink signature procedure 300. For example, the network entity 105 may transmit an SSB via a beam 305-a during a first occasion, a beam 305-b during a second occasion, a beam 305-c during a third occasion, a beam 305-d during a fourth occasion, a beam 305-e during a fifth occasion, a beam 305-f during a sixth occasion, a beam 305-g during a seventh occasion, and a beam 305-h during an eighth occasion. As such, the network entity 105 may cycle across eight different beams 305.

The network entity 105 may transmit one or more configuration messages to RIS 150-b. In some cases, the network entity 105 may transmit one or more configuration messages to the UE 115 via RIS 150-b (e.g., the RIS 150-b reflects the configuration message to the UE 115). In some cases, at least one configuration message may indicate a division of the RIS 150-b into a number of portions. Such portions may be referred to herein as sub-RISs 315 and the network entity 105 may indicate a different reflection configuration for each sub-RIS 315. In some cases, at least one configuration message may indicate that uplink communications between the UE 115 and network entity 105 are via RIS 150-b, where RIS 150-b applies a phase-change pattern to the uplink communications to distinguish between beams used by the RIS 150-b for the uplink communications. In some cases, at least one configuration message may indicate the identified set of cyclic shifts. The UE 115 may select the set of cyclic shifts based on the at least one configuration message. In some cases, the selection of the set of cyclic shifts may be based on the RIS 150-b applying the phase-change pattern to the uplink communications.

The network entity 105 may perform the uplink signature procedure 300 in an attempt to establish a connection (e.g., a beam pair link) with the UE 115 and, in some deployment scenarios, the RIS 150-b may be positioned such that the RIS 150-b may receive (and likewise reflect) one or more SSBs from the network entity 105. In some aspects, the network entity 105 may transmit a RIS configuration to the RIS 150-b (or to a RIS CU 225 associated with the RIS 150-b). In some examples, in accordance with configuration signaling from the network entity 105, the RIS 150-b may divide itself into a sub-RIS 315-a associated with a first reflection configuration, a sub-RIS 315-b associated with a second reflection configuration, a sub-RIS 315-c associated with a third reflection configuration, and a sub-RIS 315-d associated with a fourth reflection configuration. Although illustrated and described as supporting four sub-RISs 315, the RIS 150-b may support any number of sub-RISs 315. Further, although shown as including one RIS 150-b, the uplink signature procedure 300 may support any number of RISs 150. For example, sub-RISs 315 across different RISs 150 may be configured with different frequency shifts to support the implementations disclosed herein.

In some aspects, each of the reflection configurations of the sub-RISs 315 may be associated with a same receive beam for receiving signaling from the network entity 105 (e.g., each sub-RIS 315 configured to receive signaling from the network entity 105 via the beam 305-d) and different reflected beams 310. In some examples, the sub-RIS 315-a may reflect signaling via a reflected beam 310-a, the sub-RIS 315-b may reflect signaling via a reflected beam 310-b, the sub-RIS 315-c may reflect signaling via a reflected beam 310-c, and the sub-RIS 315-d may reflect signaling via a reflected beam 310-d.

In some examples, the UE 115 may receive one or more SSBs via a reflection off the RIS 150-b instead of or in addition to receiving one or more SSBs directly from the network entity 105 (e.g., without reflection off the RIS 150-b). In some cases, the UE 115 may be unaware of the configurations of each of the sub-RISs 315 or unaware of how to distinguish between different reflected beams 310 associated with different sub-RISs 315, or unaware of both. For example, the UE 115 may receive an SSB via the reflected beam 310-b during the fourth occasion (which the UE 115 may know to be associated with the beam 305-d from the network entity 105 in accordance with a configuration of a beam sweeping procedure between the UE 115 and the network entity 105) but may be unaware of which sub-RIS 315 is associated with the reflected beam 310-b or if the received SSB was reflected off the RIS 150-b at all. As such, the UE 115 may not be configured to assist the network entity 105 with a configuration of the RIS 150-b, as the UE 115 may not be configured to provide the network entity 105 with any information relating to which sub-RIS 315 (and, by extension, which RIS configuration) is able to reflect signaling to the UE 115.

In some implementations, the UE 115 and the network entity 105 may leverage different uplink signatures associated with each of the sub-RISs 315 to enable the network entity 105 to obtain, measure, or determine information relating to which sub-RIS 315 received a given random access message from the UE 115. For example, the network entity 105 may configure each sub-RIS 315 to be associated with a different uplink signature in their respective reflected directions and the UE 115 may monitor different beams in time and frequency to identify which beam provides a strongest or otherwise suitable signal strength at the UE 115 (e.g., a signal strength that satisfies a threshold) based on the uplink signature of the identified beam (e.g., beam 310-b of sub-RIS 315 has a highest signal strength).

In accordance with the configuration from the network entity 105, the sub-RIS 315-a may correspond to a phase-change pattern p₀ associated with the reflected beam 310-a, the sub-RIS 315-b may correspond to a phase-change pattern p₁ associated with the reflected beam 310-b, the sub-RIS 315-c may correspond to a phase-change pattern p₂ associated with the reflected beam 310-c, and the sub-RIS 315-d may correspond to a phase-change pattern p₃ associated with the reflected beam 310-d.

In examples in which the RIS 150-b supports four sub-RISs 315, the UE 115 may accordingly monitor four beams in time or frequency, or both (e.g., across various occasions of the uplink signature procedure 300). The UE 115 may measure a signal strength over each beam 305 and may report, to the network entity 105, a strongest beam index (corresponding to one of the beams 305 from the network entity 105). In some implementations, the UE 115 may report the identified beam index to the network entity 105 via random access signaling. In some examples, for instance, the UE 115 may select a random access occasion based on the identified beam index and may transmit a random access preamble during the selected random access occasion. In some examples, the UE 115 may select both a random access occasion and a random access preamble based on the identified beam index and may transmit the selected random access preamble during the selected random access occasion.

Based on the described techniques, RIS 150-b may receive a random access message from UE 115 on an uplink receive beam that corresponds with a downlink transmit beam on which UE 115 receives a reflected SSB from RIS 150-b. RIS 150-b may identify a phase-change pattern that corresponds to the uplink receive beam from UE 115, and apply the identified phase-change pattern to antenna elements of the RIS 150-b as RIS 150-b reflects the random access message to the network entity. As such, and in accordance with the examples of the techniques described herein, the network entity 105 may identify the phase-change pattern applied to the random access message and the uplink receive beam used to reflect the random access message. Thus, the network entity 105 may identify that the sub-RIS 315-b was used to reflect a particular SSB to UE 115 (e.g., the SSB with a highest signal strength), and that sub-RIS 315-b was used by RIS 150-b to reflect the random access message to network entity 105. Accordingly, the network entity 105 may configure the RIS 150-b for communications with UE 115, where network entity 105 communicates with the UE 115 via the RIS 150-b using the uplink receive beam and a corresponding downlink transmit beam of the RIS 150-b.

In some examples, the network entity 105 may transmit a configuration message to the UE 115 via RIS 150-b that is indicative that the uplink signature procedure 300 is being implemented. In some cases, the configuration message may indicate that uplink communications between the UE 115 and the network entity 105 are via the RIS 150-b. In some cases, the configuration message may indicate that the RIS 150-b is applying a phase-change pattern to the uplink communications to distinguish between beams used by the RIS 150-b for the uplink communications.

The network entity 105 or RIS 150-b, or both, may determine a number of phase-change patterns. The number of the multiple phase-change patterns may be based on the number of beams supported by the RIS 150-b. The network entity 105 or RIS 150-b, or both, may determine the multiple phase-change patterns based on a Hadamard matrix. In some cases, the size of the Hadamard matrix may be based on the number of beams supported by the RIS 150-b. In some cases, the multiple phase-change patterns may include a set of time-domain orthogonal cover codes. In some cases, each of the multiple phase-change patterns is unique from others of the multiple phase-change patterns based on a timing of phase-changes applied to the antenna elements of the RIS 150-b.

The RIS 150-b may reflect each instance of the SSB during a respective portion of a transmission time interval associated with transmission by the network entity 105 of the SSB, the multiple instances of the SSB being reflected during the transmission time interval. In some cases, each of the multiple instances of the SSB corresponds to a same synchronization signal block index.

In some examples, the RIS 150-b may receive a random access message from a user equipment (UE) during a random access occasion that corresponds with the synchronization signal block index and on an uplink receive beam that corresponds with one of the multiple downlink transmit beams. The RIS 150-b may sweep through multiple uplink receive beams from the UE 115, where the uplink receive beam on which the random access message is received is one of the multiple uplink receive beams. The RIS 150-b may identify a phase-change pattern that corresponds to the uplink receive beam. The phase-change pattern that is identified as corresponding to the uplink receive beam on which the random access message is received may be one of the multiple phase-change patterns. The RIS 150-b may identify multiple phase-change patterns corresponding to the multiple uplink receive beams.

In some examples, the network entity 105 may identify a set of cyclic shifts that are permissible for use with random access message transmission. In some cases, the set of cyclic shifts may be based on the RIS 150-b applying the phase-change pattern to uplink communications. The UE 115 may receive at least one configuration message from the network entity 105 that includes a correction term associated with the uplink signature procedure 300. In some instances, the UE 115 may use the correction term to select a set of cyclic shifts when the RIS 150-b is applying a phase-change pattern to the uplink communications. In some cases, the correction term may represent a number of cyclic shifts offset. In some cases, a value of the correction term may be based on a number of beams associated with the RIS 150-b. In some cases, the configuration message may be a radio resource control message.

The UE 115 may receive an indication from network entity 105 via RIS 150-b that a correction term is to be applied in selecting the set of cyclic shifts. In some cases, the indication may be a one-bit field included in either a medium access control (MAC) control element (CE) or a downlink control information (DCI) message, or a combination thereof. In some cases, the indication may indicate a mapping between zero correlation zone configuration and the set of cyclic shifts.

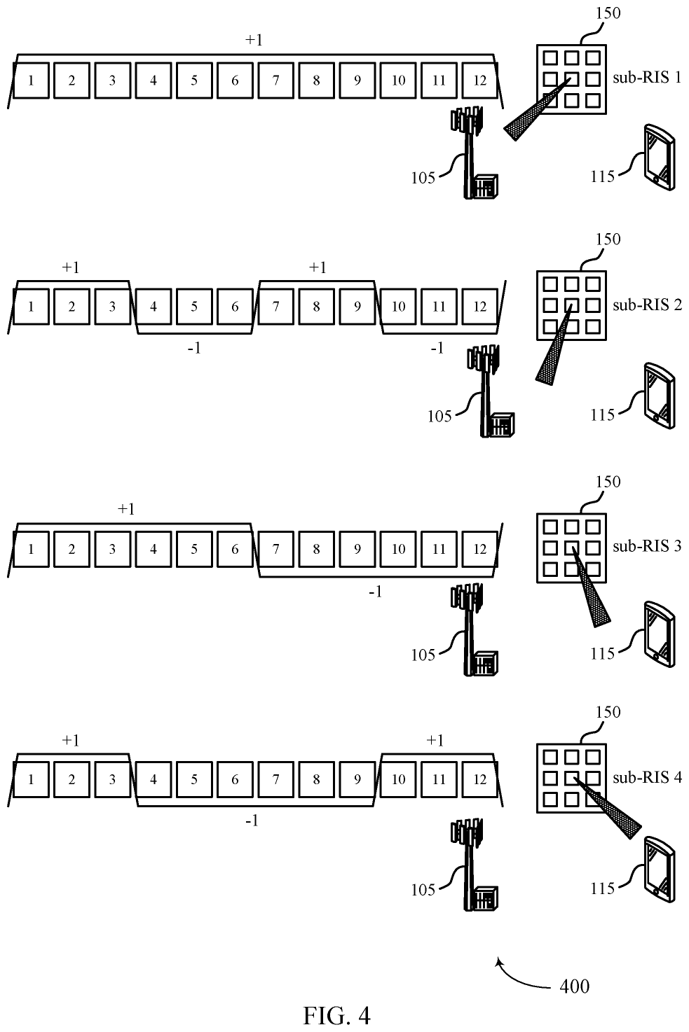

FIG. 4 illustrates an example of an uplink watermarking 400 that supports RIS-assisted access using uplink signatures in accordance with aspects of the present disclosure. In some examples, some aspects of uplink watermarking 400 may implement or be implemented by aspects of wireless communications system 100. For example, uplink watermarking 400 may include a network entity 105, a UE 115, and a RIS 150, which may be examples of a network entity 105, UE 115, or RIS 150, respectively, described with reference to FIGS. 1, 2, and 3.

In some examples, the UE 115 may receive an SSB from the network entity 105 as one of multiple instances of the SSB reflected by the RIS 150 to UE 115. The RIS 150 may reflect the SSB as multiple instances of the SSB via multiple downlink transmit beams (e.g., a number of downlink transmit beams corresponding to the number of instances of the SSB). Based on the one or more SSBs received by the UE 115, the UE 115 may transmit a random access message in the direction of the RIS 150.

The uplink watermarking 400 enables the network entity 105 to determine what beam the UE 115 (e.g., a legacy UE) determines is the best beam for communication with network entity 105. The described techniques may not include applying a watermarking procedure to downlink communications because each sub-RIS of the RIS 150 beamforms in a different directions and the UE 115 is located more or less in the path of one of those different directions. Thus, the UE 115 determines the strongest SSB that the UE 115 receives from each sub-RIS, and the UE 115 responds in the random access occasion that corresponds to the strongest SSB beam.

However, since each sub-RIS of the RIS 150 receives the same receive beam corresponding to the reflected SSB transmissions, each sub-RIS of the RIS 150 performs a unique watermarking while reflecting the random access message (e.g., via physical random access channel) towards the network entity 105. By observing the phase-change pattern the RIS 150 applies to the random access message the RIS 150 reflects to the network entity 105, the network entity 105 determines the sub-RIS associated with the strongest beam received by the UE 115. Accordingly, whether the UE 115 is a legacy UE or a new radio UE, the uplink watermarking 400 enables the network entity 105 to determine the best sub-RIS beam of RIS 150 for communication with the UE 115.

The RIS 150 may receive the random access message from the UE 115 during a random access occasion that corresponds to a synchronization signal block index of the SSB. The RIS 150 may receive the random access message on an uplink receive beam that corresponds with one of the multiple downlink transmit beams. The RIS 150 may identify a phase-change pattern that corresponds to the uplink receive beam of the random access message. The RIS 150 may reflect the random access message to the network entity 105 by applying the identified phase-change pattern to antenna elements of the RIS 150.

In some examples, the uplink watermarking 400 may include the RIS 150 applying the identified phase-change pattern to the random access message that RIS 150 reflects towards the network entity 105. In some cases, each of the multiple phase-change patterns is unique from others of the multiple phase-change patterns based on a timing of phase-changes applied to the antenna elements of the RIS 15. In some cases, the multiple phase-change patterns include multiple time-domain orthogonal cover codes. Thus, the phase-change pattern may be implemented by the RIS 150 applying a time-domain orthogonal cover code to the random access message.

In the illustrated example, the uplink watermarking 400 includes the RIS 150 applying a time-domain orthogonal cover code to the random access message that the RIS 150 reflects to the network entity 105. In some cases, the number of the multiple phase-change patterns may be based on a number of beams supported by the RIS 150. In some cases, the multiple phase-change patterns may be based on a Hadamard matrix whose size is based on a number of beams supported by the RIS 150.

In the illustrated example, the optimal RIS configuration for reflecting in the direction of beam i may be Φᵢ, for i=0, 1, . . . , NumBeams−1. In the illustrated example, the number of beams may be N (e.g., NumBeams=N). Each Φᵢ may be a diagonal NumBeams×NumBeams matrix. In the illustrated example, the RIS 150 supports four beams, thus, each of the four beams may be associated with one row of a 4×4 Hadamard matrix.

Dividing the RIS 150 into a NumBeams number of subRIS (e.g., four subRIS for NumBeams=4), a subRIS j may be based on a RIS configuration in accordance with Φ_{i,j}(t)=hⱼ(t)Φᵢ for j=0, 1, . . . , NumBeams−1, where, h; (t) is a time-varying vector which satisfies the following equation:

$${h}_{j} ( t ) = \{ \begin{matrix}{h}_{j , 0} & 0 \leq t \leq \frac{T}{NumBeams} \\ {h}_{j , 1} & \frac{T}{{NumBeams}_{…}} \leq t \leq \frac{2 T}{NumBeams} \\ {h}_{j , NumBeams - 1} & \frac{T ( NumBeams - 1 )}{NumBeams} \leq t \leq T\end{matrix}$$

where h_{j,m} corresponds to the element at the i′th row and m′th column of the NumBeams×NumBeams Hadamard matrix.

In accordance with the uplink watermarking 400, the following 4×4 Hadamard matrix produces the phase-change patterns (e.g., uplink watermarks) that are depicted in FIG. 4:

$$H = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$$

In the illustrated example, the RIS 150 applies a respective phase-change pattern to a respective subRIS. As shown, phase-change pattern [1 1 1 1] of the Hadamard matrix corresponds to a first subRIS (e.g., subRIS1), phase-change pattern [1 −1 1 −1] of the Hadamard matrix corresponds to a second subRIS (e.g., subRIS2), phase-change pattern [1 1−1 −1] of the Hadamard matrix corresponds to a third subRIS (e.g., subRIS3), and phase-change pattern [1 −1 −1 1] of the Hadamard matrix corresponds to a fourth subRIS (e.g., subRIS4).

In some examples, the configuration of each subRIS changes at specified intervals. For instance, if the duration of transmission is 800 microseconds, and the uplink watermarking 400 uses a 4×4 Hadamard matrix, then the configuration of each sub-RIS changes every 800/4=200 microseconds. Based on the indicated 4×4 Hadamard matrix, sub-RIS 1 uses configuration Φ₀ for the first 200 μs of transmission, Φ₀ for the second 200 μs, Φ₁ for the third 200 μs, and Φ₀ for the fourth 200 μs. The sub-RIS 2 uses configuration Φ₁ for the first 200 μs, −Φ₁ for the second 200 μs, Φ₁ for the third 200 μs and −Φ₁ for the fourth 200 μs. The sub-RIS 3 uses configuration Φ₂ for the first 200 μs, Φ₂ for the second 200 μs, −Φ₂ for the third 200 μs and −Φ₂ for the fourth 200 μs. The sub-RIS 4 uses configuration −Φ₃ for the first 200 μs, −Φ₃ for the second 200 μs, Φ₃ for the third 200 μs and Φ₃ for the fourth 200 μs.

In some examples, uplink watermarking 400 may affect the number of available cyclic shift positions (N_{CS}) used for uplink communication. In some cases, uplink watermarking 400 may increase autocorrelation across adjacent cyclic shifts, resulting in relatively smaller levels of N_{CS} being unusable when RIS 150 applies the phase-change pattern to the random access message.

In some cases, uplink watermarking 400 may include selecting N_{CS} based on a cell range associated with communication between network entity 105 and UE 115 via RIS 150. In some systems, choice of N_{CS} may target some cell range based on a delay spread (e.g., an assumed delay spread). In accordance with uplink watermarking 400, cell range

$$( km ) = 0.3 ( \frac{km}{μs} ) \times [ \frac{{N}_{cs} - 1}{{L}_{RA}} \times 800 μs - DS ( μs ) ] / 2.$$

Selecting N_{cs}=13 allows for a cell range of 0.76 km assuming a delay spread of 6.4 us while ensuring that one cyclic shift will not be mistaken for another. A correction term may be applied when the RIS 150 applies the phase-change pattern to the random access message. In accordance with uplink watermarking 400, a correction term may depend on the number of beams/subRIS at the RIS 150, where cell range

$$( km ) = 0.3 ( \frac{km}{μs} ) \times [ \frac{{N}_{cs} - {N}_{err , numSubRIS} - 1}{{L}_{RA}} \times 800 μs - DS ( μs ) ] / 2.$$

In some cases, aspects of uplink watermarking 400 may be based on a preamble format table associated with selecting N_{cs} in association with the RIS 150 applying the phase-change pattern to the random access message. In the provided example, the preamble format table may indicate a mapping between the zero correlation zone configuration in the first column and the set of cyclic shifts in the third column, and a mapping between the zero correlation zone configuration in the first column and the set of cyclic shifts in the fourth column. In some cases, the network entity 105, the RIS 150, or the UE 115, or any combination thereof, may be configured with the preamble format table. In some cases, one or more configuration message from the network entity 105 may indicate one or more aspects of the preamble format table to the RIS 150 or the UE 115, or both. The following is one example of the preamble format table associated with selecting N_{cs}.

| Zero | Target | | |
|---|---|---|---|
| Correlation | cell range | N_{CS} | N_{CS} with RIS |
| Zone | assuming | without RIS | watermarking |
| Configuration | 6.4 μs DS | watermarking | (N_{err,numSubRIS} = 12) |
| 0 | 0.76 km | 13 | 25 |
| 1 | 1.04 km | 15 | 27 |
| 2 | 1.47 km | 18 | 30 |
| 3 | 2.04 km | 22 | 34 |
| 4 | 2.62 km | 26 | 38 |
| . . . | . . . | . . . | . . . |

In some cases, the network entity 105 may transmit an indication that a correction term is to be applied (e.g., indicate whether RIS 150 is applying the phase-change pattern to the random access message) in accordance with UE 115 selecting N_{cs} (e.g., selecting the set of cyclic shifts). In some cases, the indication may indicate the mapping between zero correlation zone configuration in the first column and a set of cyclic shifts in the third column or the fourth column. Based on the provided example of the preamble format table, the indication may inform the UE 115 whether to use the “N_{CS} without RIS watermarking” set of cyclic shifts in the third column of the preamble format table, or to use the “N_{CS} with RIS watermarking” set of cyclic shifts in the fourth column of the preamble format table. In some cases, the indication (e.g., a single bit) may be transmitted in a medium access control (MAC) control element (CE) or a downlink control information (DCI) message, or both. In some cases, the indication may indicate a column of a preamble format table from which the UE is to select the set of cyclic shifts.

Based on the uplink watermarking 400, the value of N_{err,numSubRIS} (e.g., N_{err,numSubRIS}=12) may be communicated to the UE 115 via a configuration message. In some cases, the configuration message may be communicated via a radio resource control (RRC) message (e.g., RRC-configured).

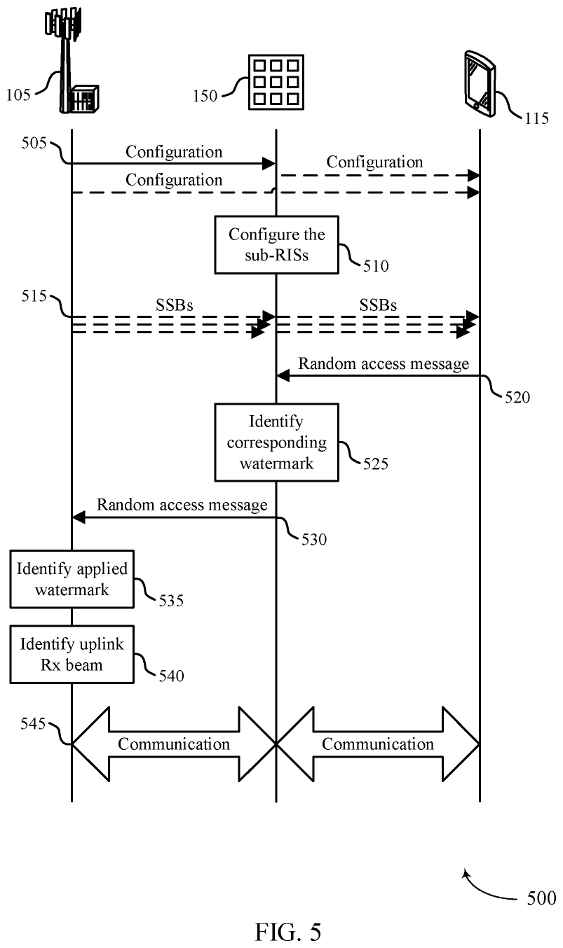

FIG. 5 illustrates an example of a process flow 500 that supports RIS-assisted access using uplink signatures in accordance with aspects of the present disclosure. In some examples, some aspects of process flow 500 may implement or be implemented by aspects of wireless communications system 100. For example, uplink watermarking 400 may include a network entity 105, a UE 115, and a RIS 150, which may be examples of a network entity 105, UE 115, or RIS 150, respectively, described with reference to FIGS. 1, 2, 3, and 4.

At 505, network entity 105 may transmit a configuration to RIS 150. In some cases, the configuration may include a configuration to divide the RIS 150 into a set of portions of the RIS 150. Such portions of the RIS 150 may be understood as or equivalently referred to as sub-RISs 315 and each sub-RIS 315 may be associated with a different reflected beam 310. In some cases, the configuration may include one or more configuration messages. As shown, RIS 150 may optionally reflect at least one configuration message to UE 115. Additionally, or alternatively, the network entity 105 may transmit one or more configuration messages directly to UE 115. Accordingly, UE 115 may receive a configuration message from the RIS 150 or the network entity 105, or both, that is indicative that uplink communications between the UE 115 and the network entity 105 are via the RIS 150. In some cases, the configuration message may indicate that the RIS 150 is applying a phase-change pattern to the uplink communications of UE 115 to distinguish between beams used by the RIS 150 for the uplink communications.

At 510, the RIS 150 (or a device, such as a RIS CU 225, controlling the RIS 150) may configure the set of sub-RISs 315 in accordance with the indication received at 905. In some implementations, the RIS 150 may configure the set of sub-RISs 315 for a reflecting of SSBs from the network entity 105 to the UE 115 and for a reflecting of a random access preamble from the UE 115 to the network entity 105.

At 515, for each beam 305 of a set of beams 305, the network entity 105 may transmit one or more SSBs associated with a synchronization signal block index. In some implementations, the network entity 105 may transmit the one or more SSBs as part of an uplink signature procedure 300 between the UE 115 and the network entity 105 via the RIS 150. Thus, the RIS 150 may receive an SSB from the network entity 105 and reflect the SSB as multiple instances of the SSB via a corresponding number of downlink transmit beams to the UE 115. The UE 115 may receive one or more instances of the SSB during a portion of a transmission time interval associated with transmission of the SSB by the network entity 105, where each of the multiple instances of the SSB corresponds to the same synchronization signal block index. The UE 115 may measure, for each beam 305 of the set of beams 305, an SSB over a set of occasions associated with the uplink signature procedure 300 and identify during which occasion the UE 115 measures an SSB having a greatest signal strength.

At 520, the UE 115 transmits a random access message during a random access occasion that corresponds to the synchronization signal block index. As shown, the RIS 150 receives the random access message from the UE 115 and reflects the random access message to the network entity 105. The RIS 150 receives the random access message during the random access occasion that corresponds with the synchronization signal block index and on an uplink receive beam that corresponds with one of the plurality of downlink transmit beams.

At 525, the RIS 150 determines which watermark among multiple watermarks (e.g., which phase-change pattern among multiple phase-change patterns) corresponds to the uplink receive beam on which the random access message is received. The number of watermarks (e.g., number of phase-change patterns) may be based on a number of beams supported by the RIS 150. The number of beams supported by the RIS 150 may be based on the configuration that the RIS 150 receives from the network entity 105.

At 530, the RIS 150 reflects the random access message to the network entity 105. Before or while the RIS 150 reflects the random access message to the network entity 105, the RIS 150 may apply to the random access message the watermark (e.g., phase-change pattern) that the RIS 150 identifies as corresponding to the uplink receive beam on which the random access message is received by the RIS 150. In some cases, the RIS 150 may apply the watermark to the random access message by applying the watermark to antenna elements that the RIS 150 uses to reflect the random access message to the network entity 105. Accordingly, the network entity 105 may receive the random access message from the UE 115, via the RIS 150, during the random access occasion that corresponds with the synchronization signal block index.

At 535, the network entity 105 may identify the watermark (e.g., phase-change pattern) applied to the random access message received from the RIS 150. The network entity 105 may identify the watermark among multiple watermarks that correspond to different uplink receive beams used by the RIS 150.

At 540, the network entity 105 may determine the uplink receive beam used by the RIS 150 to receive the random access message from the UE 115 based at least in part on the identified watermark applied to the random access message. In some cases, the network entity 105 may identify a downlink transmit beam of the RIS 150 that corresponds to the uplink receive beam on which the random access message is received by the RIS 150.

At 545, the network entity 105 and the UE 115 communicate via the RIS 150. To communicate with the UE 115, the network entity 105 may use the downlink transmit beam corresponding to the uplink receive beam used by the RIS 150 to receive the random access message from the UE 115, the RIS 150 reflecting the downlink transmissions to the UE 115. To communicate with the network entity 105, the UE 115 may use the uplink receive beam that the UE 115 used to transmit the random access message to the RIS 150, the RIS 150 reflecting the uplink transmissions to the network entity 105.

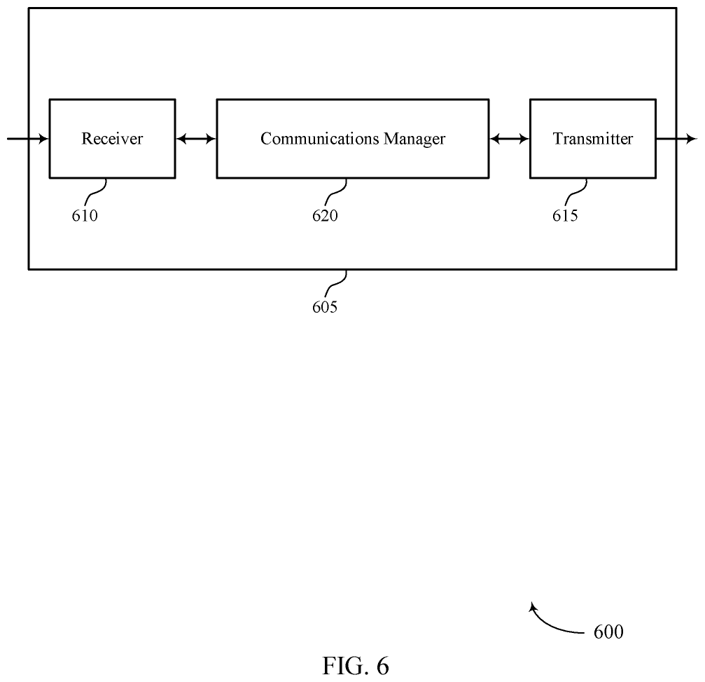

FIG. 6 shows a block diagram 600 of a device 605 that supports RIS-assisted access using uplink signatures in accordance with aspects of the present disclosure. The device 605 may be an example of aspects of a RIS 150 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to RIS-assisted access using uplink signatures). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RIS-assisted access using uplink signatures). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of RIS-assisted access using uplink signatures as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a RIS in accordance with examples as disclosed herein. For example, the communications manager 620 may be configured as or otherwise support a means for receiving, from a network entity, a synchronization signal block associated with a synchronization signal block index. The communications manager 620 may be configured as or otherwise support a means for reflecting the synchronization signal block as a set of multiple instances of the synchronization signal block via a corresponding set of multiple downlink transmit beams. The communications manager 620 may be configured as or otherwise support a means for receiving a random access message from a UE during a random access occasion that corresponds with the synchronization signal block index and on an uplink receive beam that corresponds with one of the set of multiple downlink transmit beams. The communications manager 620 may be configured as or otherwise support a means for identifying a phase-change pattern that corresponds to the uplink receive beam. The communications manager 620 may be configured as or otherwise support a means for reflecting the random access message to the network entity by applying the phase-change pattern to antenna elements of the RIS.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for improvements in system efficiency such that a device may improve one or more aspects of communication (e.g., increased signal quality, increased throughput, increased transmission efficiency, increased power savings, etc.) between a UE, a RIS, and network entity, such as when an object blocks or otherwise inhibits a line-of-sight (LoS) link between the network entity and the UE. Additionally, described techniques may result in reduced processing, reduced power consumption, more efficient utilization of communication resources.

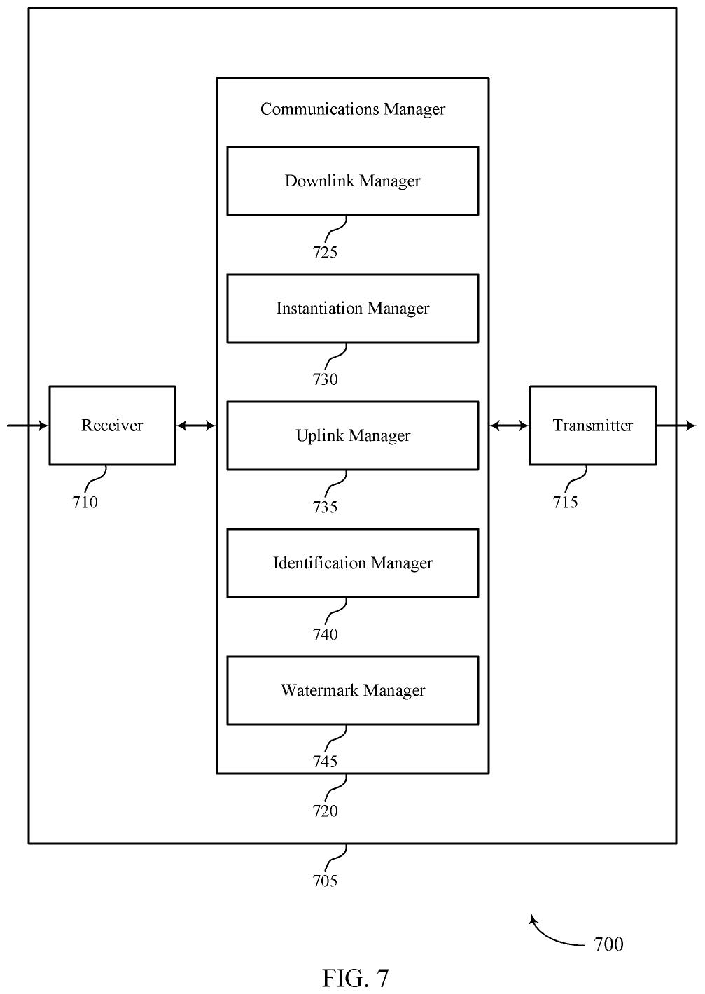

FIG. 7 shows a block diagram 700 of a device 705 that supports RIS-assisted access using uplink signatures in accordance with aspects of the present disclosure. The device 705 may be an example of aspects of a device 605 or a RIS 150 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to RIS-assisted access using uplink signatures). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to RIS-assisted access using uplink signatures). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of RIS-assisted access using uplink signatures as described herein. For example, the communications manager 720 may include a downlink manager 725, an instantiation manager 730, an uplink manager 735, an identification manager 740, a watermark manager 745, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a RIS in accordance with examples as disclosed herein. The downlink manager 725 may be configured as or otherwise support a means for receiving, from a network entity, a synchronization signal block associated with a synchronization signal block index. The instantiation manager 730 may be configured as or otherwise support a means for reflecting the synchronization signal block as a set of multiple instances of the synchronization signal block via a corresponding set of multiple downlink transmit beams. The uplink manager 735 may be configured as or otherwise support a means for receiving a random access message from a UE during a random access occasion that corresponds with the synchronization signal block index and on an uplink receive beam that corresponds with one of the set of multiple downlink transmit beams. The identification manager 740 may be configured as or otherwise support a means for identifying a phase-change pattern that corresponds to the uplink receive beam. The watermark manager 745 may be configured as or otherwise support a means for reflecting the random access message to the network entity by applying the phase-change pattern to antenna elements of the RIS.

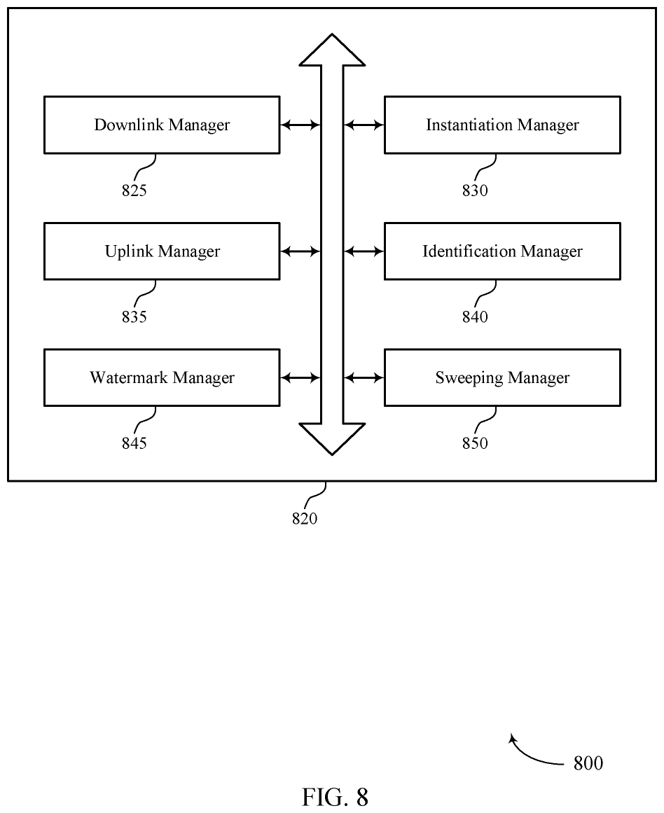

FIG. 8 shows a block diagram 800 of a communications manager 820 that supports RIS-assisted access using uplink signatures in accordance with aspects of the present disclosure. The communications manager 820 may be an example of aspects of a communications manager 620, a communications manager 720, or both, as described herein. The communications manager 820, or various components thereof, may be an example of means for performing various aspects of RIS-assisted access using uplink signatures as described herein. For example, the communications manager 820 may include a downlink manager 825, an instantiation manager 830, an uplink manager 835, an identification manager 840, a watermark manager 845, a sweeping manager 850, or any combination thereof. Each of these components may communicate, directly or indirectly, with one another (e.g., via one or more buses).

The communications manager 820 may support wireless communication at a RIS in accordance with examples as disclosed herein. The downlink manager 825 may be configured as or otherwise support a means for receiving, from a network entity, a synchronization signal block associated with a synchronization signal block index. The instantiation manager 830 may be configured as or otherwise support a means for reflecting the synchronization signal block as a set of multiple instances of the synchronization signal block via a corresponding set of multiple downlink transmit beams. The uplink manager 835 may be configured as or otherwise support a means for receiving a random access message from a UE during a random access occasion that corresponds with the synchronization signal block index and on an uplink receive beam that corresponds with one of the set of multiple downlink transmit beams. The identification manager 840 may be configured as or otherwise support a means for identifying a phase-change pattern that corresponds to the uplink receive beam. The watermark manager 845 may be configured as or otherwise support a means for reflecting the random access message to the network entity by applying the phase-change pattern to antenna elements of the RIS.

In some examples, to support receiving the random access message from the UE during the random access occasion and on the uplink receive beam, the sweeping manager 850 may be configured as or otherwise support a means for sweeping through a set of multiple uplink receive beams, the uplink receive beam on which the random access message is received being one of the set of multiple uplink receive beams.

In some examples, the sweeping manager 850 may be configured as or otherwise support a means for identifying a set of multiple phase-change patterns corresponding to the set of multiple uplink receive beams, the phase-change pattern identified as corresponding to the uplink receive beam on which the random access message is received being one of the set of multiple phase-change patterns.

In some examples, to support identifying the set of multiple phase-change patterns, the sweeping manager 850 may be configured as or otherwise support a means for determining a number of the set of multiple phase-change patterns, the number of the set of multiple phase-change patterns based on a number of beams supported by the RIS.

In some examples, to support identifying the set of multiple phase-change patterns, the sweeping manager 850 may be configured as or otherwise support a means for determining the set of multiple phase-change patterns based on a Hadamard matrix whose size is based on a number of beams supported by the RIS. In some examples, the set of multiple phase-change patterns are a set of multiple time-domain orthogonal cover codes. In some examples, each of the set of multiple phase-change patterns is unique from others of the set of multiple phase-change patterns based on a timing of phase-changes applied to the antenna elements of the RIS. In some examples, each of the set of multiple instances of the synchronization signal block corresponds to a same synchronization signal block index.

In some examples, to support reflecting the synchronization signal block, the instantiation manager 830 may be configured as or otherwise support a means for reflecting each instance of the synchronization signal block during a respective portion of a transmission time interval associated with transmission by the network entity of the synchronization signal block, the set of multiple the instances of the synchronization signal block being reflected during the transmission time interval.

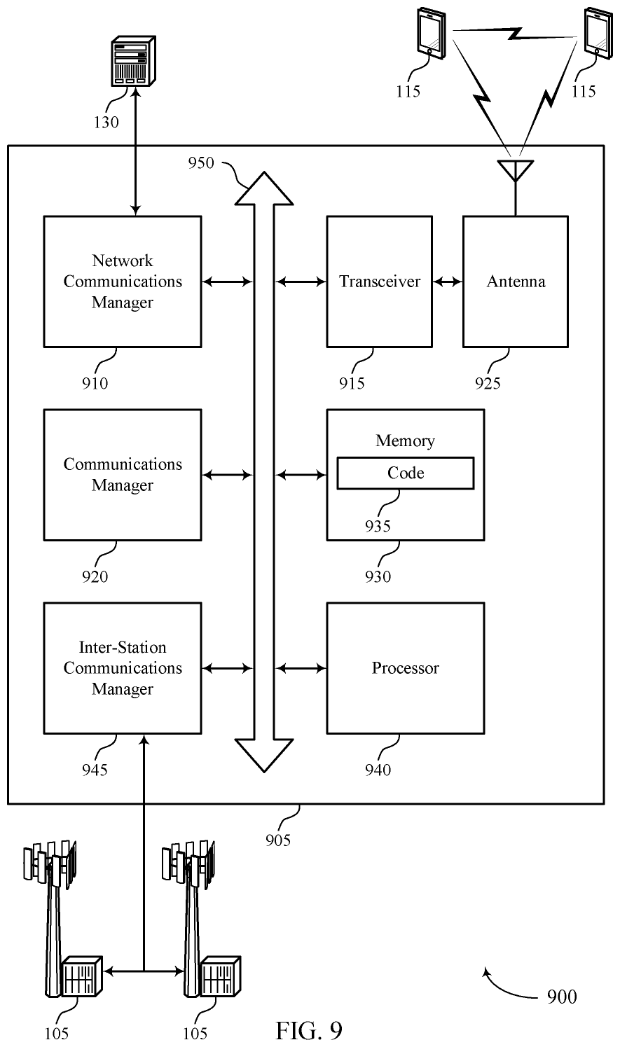

FIG. 9 shows a diagram of a system 900 including a device 905 that supports RIS-assisted access using uplink signatures in accordance with aspects of the present disclosure. The device 905 may be an example of or include the components of a device 605, a device 705, or a RIS 150 as described herein. The device 905 may include components for bi-directional voice and data communications including components for transmitting and receiving communications, such as a communications manager 920, a network communications manager 910, a transceiver 915, an antenna 925, a memory 930, code 935, a processor 940, and an inter-station communications manager 945. These components may be in electronic communication or otherwise coupled (e.g., operatively, communicatively, functionally, electronically, electrically) via one or more buses (e.g., a bus 950).

The network communications manager 910 may manage communications with a core network 130 (e.g., via one or more wired backhaul links). For example, the network communications manager 910 may manage the transfer of data communications for client devices, such as one or more UEs 115.

In some cases, the device 905 may include a single antenna 925. However, in some other cases the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include RAM and ROM. The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a BIOS which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting RIS-assisted access using uplink signatures). For example, the device 905 or a component of the device 905 may include a processor 940 and memory 930 coupled to the processor 940, the processor 940 and memory 930 configured to perform various functions described herein.

The inter-station communications manager 945 may manage communications with other network entities 105, and may include a controller or scheduler for controlling communications with UEs 115 in cooperation with other network entities 105. For example, the inter-station communications manager 945 may coordinate scheduling for transmissions to UEs 115 for various interference mitigation techniques such as beamforming or joint transmission. In some examples, the inter-station communications manager 945 may provide an X2 interface within an LTE/LTE-A wireless communications network technology to provide communication between network entities 105.

The communications manager 920 may support wireless communication at a RIS in accordance with examples as disclosed herein. For example, the communications manager 920 may be configured as or otherwise support a means for receiving, from a network entity, a synchronization signal block associated with a synchronization signal block index. The communications manager 920 may be configured as or otherwise support a means for reflecting the synchronization signal block as a set of multiple instances of the synchronization signal block via a corresponding set of multiple downlink transmit beams. The communications manager 920 may be configured as or otherwise support a means for receiving a random access message from a UE during a random access occasion that corresponds with the synchronization signal block index and on an uplink receive beam that corresponds with one of the set of multiple downlink transmit beams. The communications manager 920 may be configured as or otherwise support a means for identifying a phase-change pattern that corresponds to the uplink receive beam. The communications manager 920 may be configured as or otherwise support a means for reflecting the random access message to the network entity by applying the phase-change pattern to antenna elements of the RIS.

By including or configuring the communications manager 920 in accordance with examples as described herein, the device 905 may support techniques for improvements in system efficiency such that a device may improve one or more aspects of communication (e.g., increased signal quality, increased throughput, increased transmission efficiency, increased power savings, etc.) between a UE, a RIS, and network entity, such as when an object blocks or otherwise inhibits a line-of-sight (LoS) link between the network entity and the UE. Additionally, described techniques may result in improved communication reliability, reduced latency, improved user experience related to reduced processing, reduced power consumption, more efficient utilization of communication resources, improved coordination between devices, longer battery life, improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of RIS-assisted access using uplink signatures as described herein, or the processor 940 and the memory 930 may be otherwise configured to perform or support such operations.

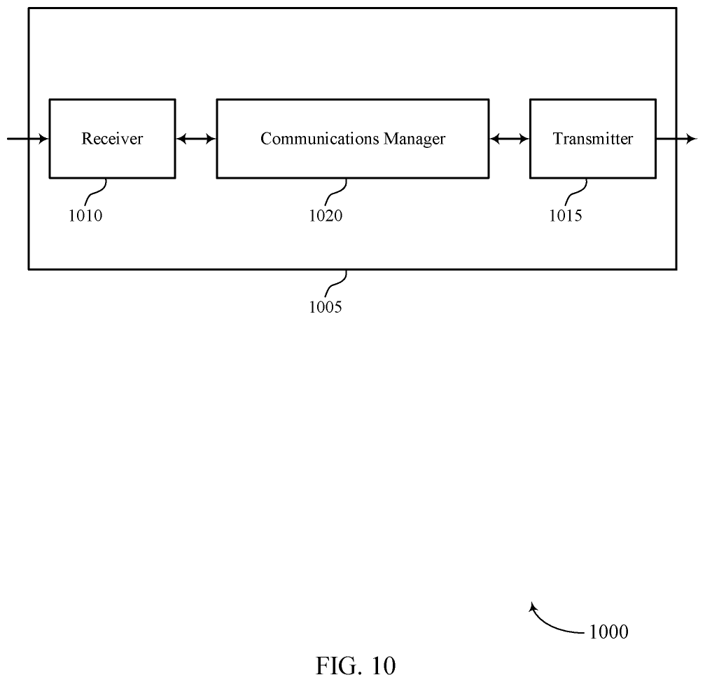

FIG. 10 shows a block diagram 1000 of a device 1005 that supports RIS-assisted access using uplink signatures in accordance with aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to RIS-assisted access using uplink signatures). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to RIS-assisted access using uplink signatures). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of RIS-assisted access using uplink signatures as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a network entity in accordance with examples as disclosed herein. For example, the communications manager 1020 may be configured as or otherwise support a means for transmitting, via a RIS, a synchronization signal block associated with a synchronization signal block index. The communications manager 1020 may be configured as or otherwise support a means for receiving a random access message from a UE during a random access occasion that corresponds with the synchronization signal block index. The communications manager 1020 may be configured as or otherwise support a means for identifying a phase-change pattern of the random access message received at the network entity, the phase-change pattern being one of a set of multiple phase-change patterns corresponding to different uplink receive beams used by the RIS. The communications manager 1020 may be configured as or otherwise support a means for determining an uplink receive beam used by the RIS to receive the random access message from the UE based on the phase-change pattern. The communications manager 1020 may be configured as or otherwise support a means for communicating with the UE via the RIS using the uplink receive beam and a corresponding downlink transmit beam of the RIS.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for improvements in system efficiency such that a device may improve one or more aspects of communication (e.g., increased signal quality, increased throughput, increased transmission efficiency, increased power savings, etc.) between a UE, a RIS, and network entity, such as when an object blocks or otherwise inhibits a line-of-sight (LoS) link between the network entity and the UE. Additionally, described techniques may result in reduced processing, reduced power consumption, more efficient utilization of communication resources.

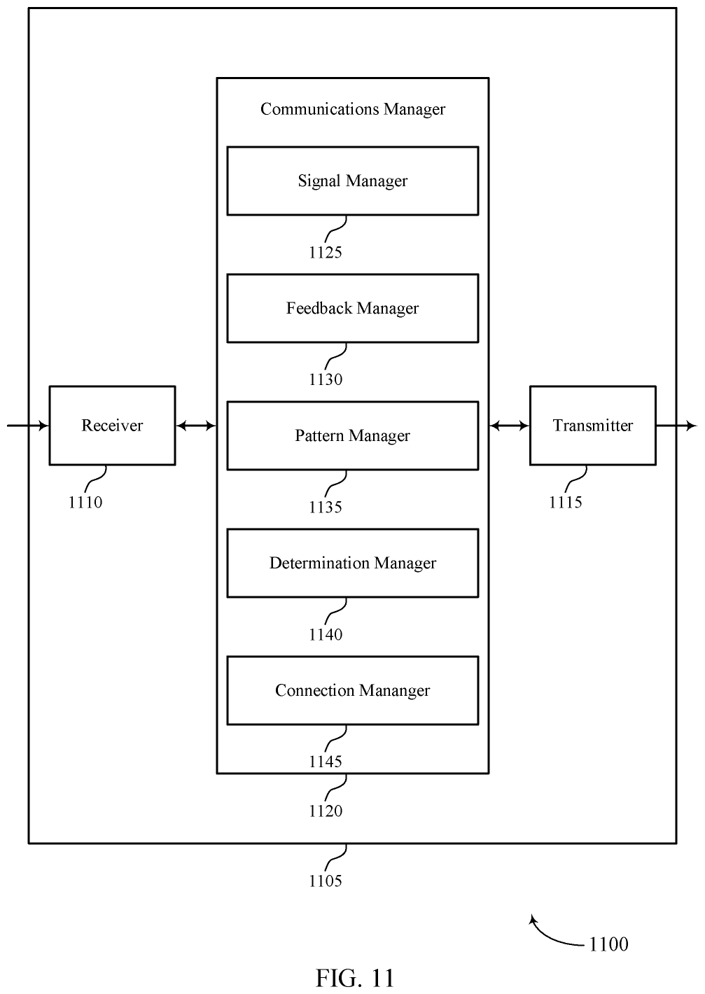

FIG. 11 shows a block diagram 1100 of a device 1105 that supports RIS-assisted access using uplink signatures in accordance with aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to RIS-assisted access using uplink signatures). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to RIS-assisted access using uplink signatures). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of RIS-assisted access using uplink signatures as described herein. For example, the communications manager 1120 may include a signal manager 1125, a feedback manager 1130, a pattern manager 1135, a determination manager 1140, a connection manager 1145, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a network entity in accordance with examples as disclosed herein. The signal manager 1125 may be configured as or otherwise support a means for transmitting, via a RIS, a synchronization signal block associated with a synchronization signal block index. The feedback manager 1130 may be configured as or otherwise support a means for receiving a random access message from a UE during a random access occasion that corresponds with the synchronization signal block index. The pattern manager 1135 may be configured as or otherwise support a means for identifying a phase-change pattern of the random access message received at the network entity, the phase-change pattern being one of a set of multiple phase-change patterns corresponding to different uplink receive beams used by the RIS. The determination manager 1140 may be configured as or otherwise support a means for determining an uplink receive beam used by the RIS to receive the random access message from the UE based on the phase-change pattern. The connection manager 1145 may be configured as or otherwise support a means for communicating with the UE via the RIS using the uplink receive beam and a corresponding downlink transmit beam of the RIS.

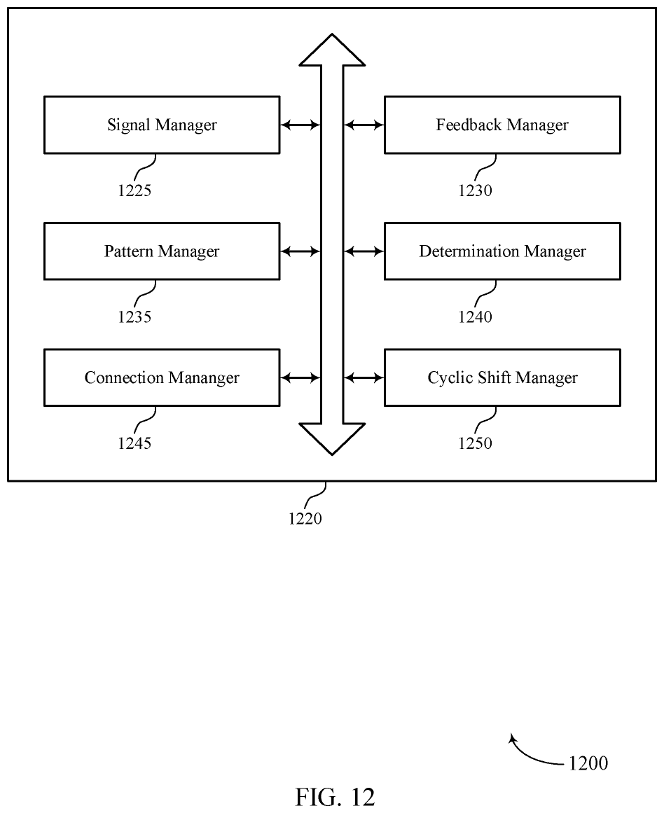

FIG. 12 shows a block diagram 1200 of a communications manager 1220 that supports RIS-assisted access using uplink signatures in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of RIS-assisted access using uplink signatures as described herein. For example, the communications manager 1220 may include a signal manager 1225, a feedback manager 1230, a pattern manager 1235, a determination manager 1240, a connection manager 1245, a cyclic shift manager 1250, or any combination thereof. Each of these components may communicate, directly or indirectly, with one another (e.g., via one or more buses).

The communications manager 1220 may support wireless communication at a network entity in accordance with examples as disclosed herein. The signal manager 1225 may be configured as or otherwise support a means for transmitting, via a RIS, a synchronization signal block associated with a synchronization signal block index. The feedback manager 1230 may be configured as or otherwise support a means for receiving a random access message from a UE during a random access occasion that corresponds with the synchronization signal block index. The pattern manager 1235 may be configured as or otherwise support a means for identifying a phase-change pattern of the random access message received at the network entity, the phase-change pattern being one of a set of multiple phase-change patterns corresponding to different uplink receive beams used by the RIS. The determination manager 1240 may be configured as or otherwise support a means for determining an uplink receive beam used by the RIS to receive the random access message from the UE based on the phase-change pattern. The connection manager 1245 may be configured as or otherwise support a means for communicating with the UE via the RIS using the uplink receive beam and a corresponding downlink transmit beam of the RIS.

In some examples, the determination manager 1240 may be configured as or otherwise support a means for determining a number of the set of multiple phase-change patterns, the number of the set of multiple phase-change patterns based on a number of beams supported by the RIS.

In some examples, the determination manager 1240 may be configured as or otherwise support a means for determining the set of multiple phase-change patterns based on a Hadamard matrix whose size is based on a number of beams supported by the RIS. In some examples, the set of multiple phase-change patterns are a set of multiple time-domain orthogonal cover codes. In some examples, each of the set of multiple phase-change patterns is unique from others of the set of multiple phase-change patterns based on a timing of phase-changes applied to antenna elements of the RIS.

In some examples, the cyclic shift manager 1250 may be configured as or otherwise support a means for identifying a set of cyclic shifts that are permissible for use with random access message transmission, where the set of cyclic shifts is based on the RIS applying the phase-change pattern to uplink communications.

In some examples, the cyclic shift manager 1250 may be configured as or otherwise support a means for transmitting a configuration message that includes a correction term to be used by the UE in selecting the set of cyclic shifts when the RIS is applying the phase-change pattern to the uplink communications, where the correction term represents a number of cyclic shifts offset. In some examples, the configuration message is a radio resource control message. In some examples, a value of the correction term is based on a number of beams associated with the RIS.

In some examples, the cyclic shift manager 1250 may be configured as or otherwise support a means for transmitting an indication that the correction term is to be applied by the UE in selecting the set of cyclic shifts. In some examples, the indication is or includes a one-bit field included in either a medium access control (MAC) control element (CE) or a DCI message. In some examples, the indication further indicates a mapping between zero correlation zone configuration and the set of cyclic shifts.

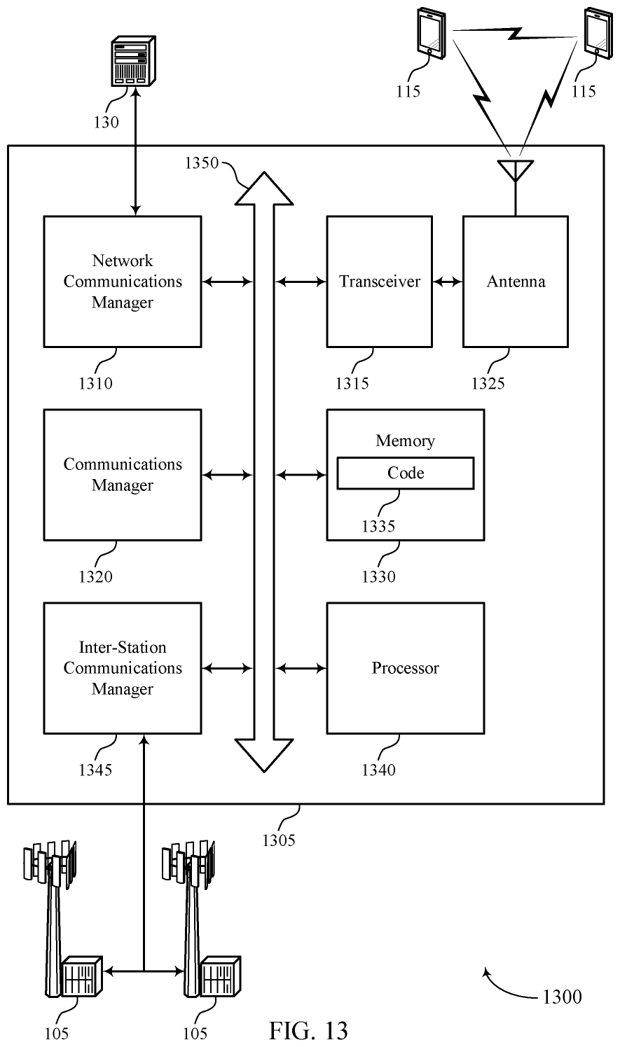

FIG. 13 shows a diagram of a system 1300 including a device 1305 that supports RIS-assisted access using uplink signatures in accordance with aspects of the present disclosure. The device 1305 may be an example of or include the components of a device 1005, a device 1105, or a network entity 105 as described herein. The device 1305 may communicate wirelessly with one or more network entities 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting RIS-assisted access using uplink signatures). For example, the device 1305 or a component of the device 1305 may include a processor 1340 and memory 1330 coupled with or to the processor 1340, the processor 1340 and memory 1330 configured to perform various functions described herein.

The inter-station communications manager 1345 may manage communications with other network entities 105, and may include a controller or scheduler for controlling communications with UEs 115 in cooperation with other network entities 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting, via a RIS, a synchronization signal block associated with a synchronization signal block index. The communications manager 1320 may be configured as or otherwise support a means for receiving a random access message from a UE during a random access occasion that corresponds with the synchronization signal block index. The communications manager 1320 may be configured as or otherwise support a means for identifying a phase-change pattern of the random access message received at the network entity, the phase-change pattern being one of a set of multiple phase-change patterns corresponding to different uplink receive beams used by the RIS. The communications manager 1320 may be configured as or otherwise support a means for determining an uplink receive beam used by the RIS to receive the random access message from the UE based on the phase-change pattern. The communications manager 1320 may be configured as or otherwise support a means for communicating with the UE via the RIS using the uplink receive beam and a corresponding downlink transmit beam of the RIS.

By including or configuring the communications manager 1320 in accordance with examples as described herein, the device 1305 may support techniques for improvements in system efficiency such that a device may improve one or more aspects of communication (e.g., increased signal quality, increased throughput, increased transmission efficiency, increased power savings, etc.) between a UE, a RIS, and network entity, such as when an object blocks or otherwise inhibits a line-of-sight (LoS) link between the network entity and the UE. Additionally, described techniques may result in improved communication reliability, reduced latency, improved user experience related to reduced processing, reduced power consumption, more efficient utilization of communication resources, improved coordination between devices, longer battery life, improved utilization of processing capability.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of RIS-assisted access using uplink signatures as described herein, or the processor 1340 and the memory 1330 may be otherwise configured to perform or support such operations.

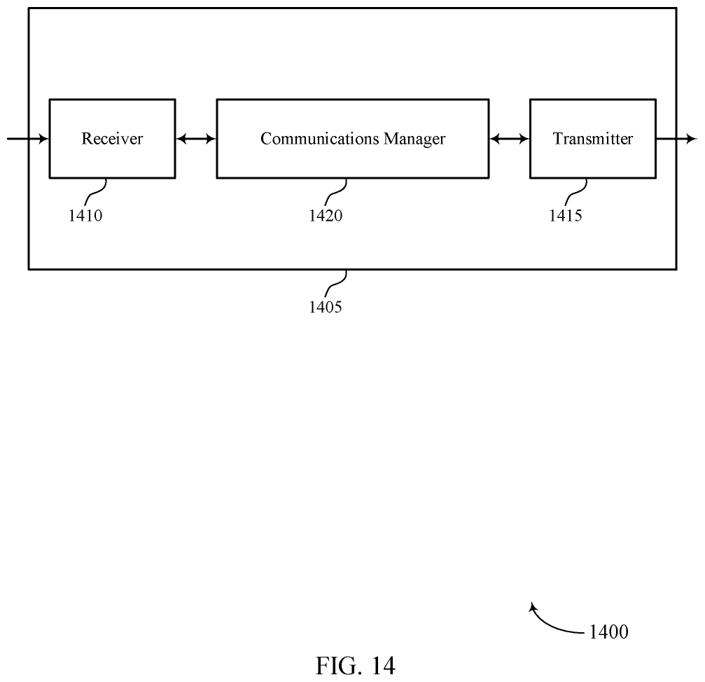

FIG. 14 shows a block diagram 1400 of a device 1405 that supports RIS-assisted access using uplink signatures in accordance with aspects of the present disclosure. The device 1405 may be an example of aspects of a UE 115 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to RIS-assisted access using uplink signatures). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to RIS-assisted access using uplink signatures). In some examples, the transmitter 1415 may be co-located with a receiver 1410 in a transceiver module. The transmitter 1415 may utilize a single antenna or a set of multiple antennas.

The communications manager 1420, the receiver 1410, the transmitter 1415, or various combinations thereof or various components thereof may be examples of means for performing various aspects of RIS-assisted access using uplink signatures as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1420, the receiver 1410, the transmitter 1415, or various combinations or components thereof may be implemented in code (e.g., as communications management software or firmware) executed by a processor. If implemented in code executed by a processor, the functions of the communications manager 1420, the receiver 1410, the transmitter 1415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1420 may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communication at a UE in accordance with examples as disclosed herein. For example, the communications manager 1420 may be configured as or otherwise support a means for receiving a message at the UE that is indicative that uplink communications between the UE and a network entity are via a RIS that is applying a phase-change pattern to the uplink communications to distinguish between beams used by the RIS for the uplink communications. The communications manager 1420 may be configured as or otherwise support a means for receiving a synchronization signal block from the network entity during a portion of a transmission time interval associated with transmission by the network entity of the synchronization signal block, the synchronization signal block being received as one of a set of multiple instances of the synchronization signal block reflected by the RIS, where each of the set of multiple instances of the synchronization signal block corresponds to a same synchronization signal block index. The communications manager 1420 may be configured as or otherwise support a means for transmitting a random access message during a random access occasion that corresponds to the synchronization signal block index.

By including or configuring the communications manager 1420 in accordance with examples as described herein, the device 1405 (e.g., a processor controlling or otherwise coupled to the receiver 1410, the transmitter 1415, the communications manager 1420, or a combination thereof) may support techniques for improvements in system efficiency such that a device may improve one or more aspects of communication (e.g., increased signal quality, increased throughput, increased transmission efficiency, increased power savings, etc.) between a UE, a RIS, and network entity, such as when an object blocks or otherwise inhibits a line-of-sight (LoS) link between the network entity and the UE. Additionally, described techniques may result in reduced processing, reduced power consumption, more efficient utilization of communication resources.

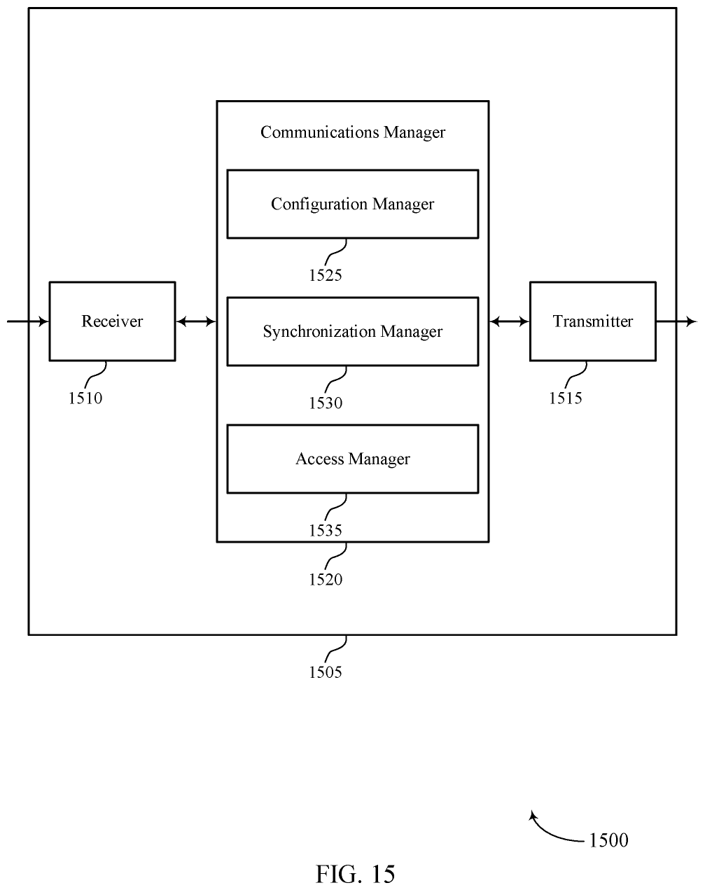

FIG. 15 shows a block diagram 1500 of a device 1505 that supports RIS-assisted access using uplink signatures in accordance with aspects of the present disclosure. The device 1505 may be an example of aspects of a device 1405 or a UE 115 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to RIS-assisted access using uplink signatures). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to RIS-assisted access using uplink signatures). In some examples, the transmitter 1515 may be co-located with a receiver 1510 in a transceiver module. The transmitter 1515 may utilize a single antenna or a set of multiple antennas.

The device 1505, or various components thereof, may be an example of means for performing various aspects of RIS-assisted access using uplink signatures as described herein. For example, the communications manager 1520 may include a configuration manager 1525, a synchronization manager 1530, an access manager 1535, or any combination thereof. The communications manager 1520 may be an example of aspects of a communications manager 1420 as described herein. In some examples, the communications manager 1520, or various components thereof, may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communication at a UE in accordance with examples as disclosed herein. The configuration manager 1525 may be configured as or otherwise support a means for receiving a message at the UE that is indicative that uplink communications between the UE and a network entity are via a RIS that is applying a phase-change pattern to the uplink communications to distinguish between beams used by the RIS for the uplink communications. The synchronization manager 1530 may be configured as or otherwise support a means for receiving a synchronization signal block from the network entity during a portion of a transmission time interval associated with transmission by the network entity of the synchronization signal block, the synchronization signal block being received as one of a set of multiple instances of the synchronization signal block reflected by the RIS, where each of the set of multiple instances of the synchronization signal block corresponds to a same synchronization signal block index. The access manager 1535 may be configured as or otherwise support a means for transmitting a random access message during a random access occasion that corresponds to the synchronization signal block index.

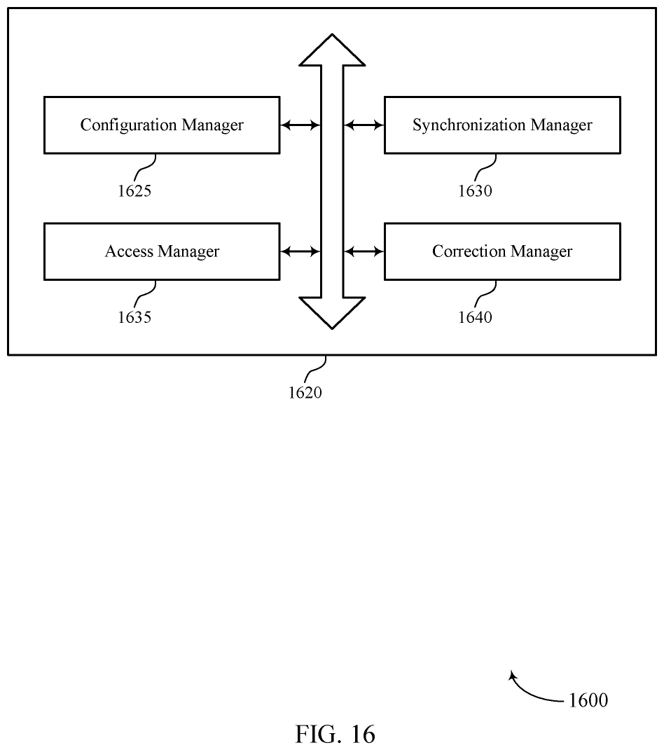

FIG. 16 shows a block diagram 1600 of a communications manager 1620 that supports RIS-assisted access using uplink signatures in accordance with aspects of the present disclosure. The communications manager 1620 may be an example of aspects of a communications manager 1420, a communications manager 1520, or both, as described herein. The communications manager 1620, or various components thereof, may be an example of means for performing various aspects of RIS-assisted access using uplink signatures as described herein. For example, the communications manager 1620 may include a configuration manager 1625, a synchronization manager 1630, an access manager 1635, a correction manager 1640, or any combination thereof. Each of these components may communicate, directly or indirectly, with one another (e.g., via one or more buses).

The communications manager 1620 may support wireless communication at a UE in accordance with examples as disclosed herein. The configuration manager 1625 may be configured as or otherwise support a means for receiving a message at the UE that is indicative that uplink communications between the UE and a network entity are via a RIS that is applying a phase-change pattern to the uplink communications to distinguish between beams used by the RIS for the uplink communications. The synchronization manager 1630 may be configured as or otherwise support a means for receiving a synchronization signal block from the network entity during a portion of a transmission time interval associated with transmission by the network entity of the synchronization signal block, the synchronization signal block being received as one of a set of multiple instances of the synchronization signal block reflected by the RIS, where each of the set of multiple instances of the synchronization signal block corresponds to a same synchronization signal block index. The access manager 1635 may be configured as or otherwise support a means for transmitting a random access message during a random access occasion that corresponds to the synchronization signal block index.

In some examples, the correction manager 1640 may be configured as or otherwise support a means for selecting a set of cyclic shifts that are permissible for application to transmission of the random access message, where selection of the set of cyclic shifts is based on the RIS applying the phase-change pattern to the uplink communications.

In some examples, to support selecting the set of cyclic shifts, the correction manager 1640 may be configured as or otherwise support a means for receiving a configuration message that includes a correction term to be used in selecting the set of cyclic shifts when the RIS is applying the phase-change pattern to the uplink communications, where the correction term represents a number of cyclic shifts offset. In some examples, a value of the correction term is based on a number of beams associated with the RIS. In some examples, to support selecting the set of cyclic shifts, the correction manager 1640 may be configured as or otherwise support a means for receiving an indication that the correction term is to be applied in selecting the set of cyclic shifts.

In some examples, the indication is or includes a one-bit field included in either a medium access control (MAC) control element (CE) or a DCI message. In some examples, the indication further indicates a mapping between zero correlation zone configuration and the set of cyclic shifts. In some examples, the configuration message is a radio resource control message.

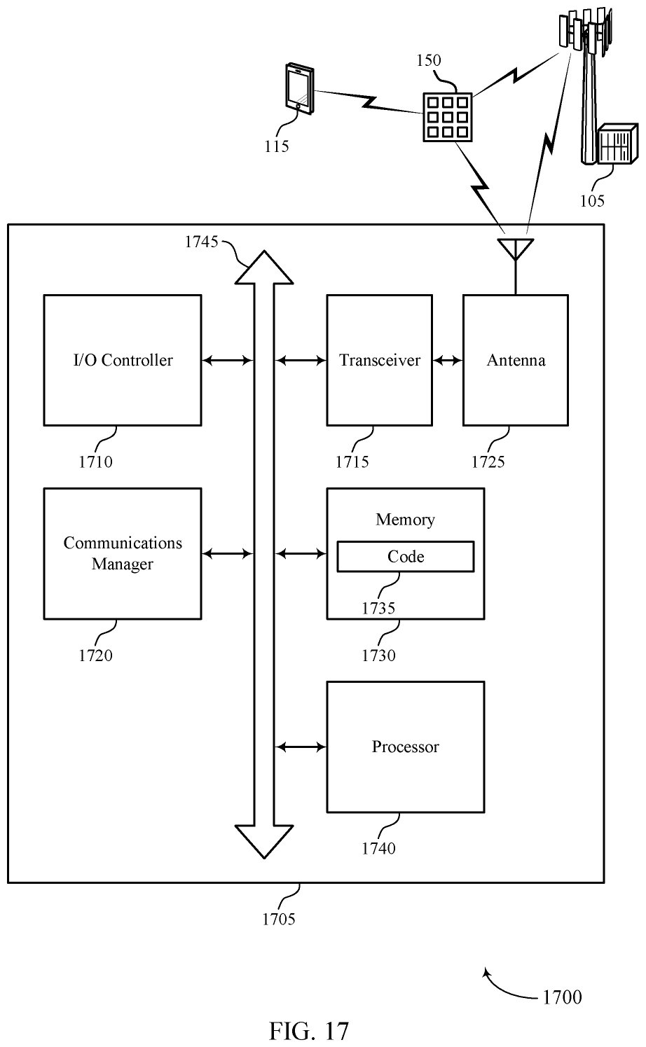

FIG. 17 shows a diagram of a system 1700 including a device 1705 that supports RIS-assisted access using uplink signatures in accordance with aspects of the present disclosure. The device 1705 may be an example of or include the components of a device 1405, a device 1505, or a UE 115 as described herein. The device 1705 may communicate wirelessly with one or more network entities 105, RISs 150, UEs 115, or any combination thereof. The device 1705 may include components for bi-directional voice and data communications including components for transmitting and receiving communications, such as a communications manager 1720, an input/output (I/O) controller 1710, a transceiver 1715, an antenna 1725, a memory 1730, code 1735, and a processor 1740. These components may be in electronic communication or otherwise coupled (e.g., operatively, communicatively, functionally, electronically, electrically) via one or more buses (e.g., a bus 1745).

The I/O controller 1710 may manage input and output signals for the device 1705. The I/O controller 1710 may also manage peripherals not integrated into the device 1705. In some cases, the I/O controller 1710 may represent a physical connection or port to an external peripheral. In some cases, the I/O controller 1710 may utilize an operating system such as iOS®, ANDROID®, MS-DOS®, MS-WINDOWS®, OS/2®, UNIX®, LINUX®), or another known operating system. Additionally or alternatively, the I/O controller 1710 may represent or interact with a modem, a keyboard, a mouse, a touchscreen, or a similar device. In some cases, the I/O controller 1710 may be implemented as part of a processor, such as the processor 1740. In some cases, a user may interact with the device 1705 via the I/O controller 1710 or via hardware components controlled by the I/O controller 1710.

In some cases, the device 1705 may include a single antenna 1725. However, in some other cases, the device 1705 may have more than one antenna 1725, which may be capable of concurrently transmitting or receiving multiple wireless transmissions. The transceiver 1715 may communicate bi-directionally, via the one or more antennas 1725, wired, or wireless links as described herein. For example, the transceiver 1715 may represent a wireless transceiver and may communicate bi-directionally with another wireless transceiver. The transceiver 1715 may also include a modem to modulate the packets, to provide the modulated packets to one or more antennas 1725 for transmission, and to demodulate packets received from the one or more antennas 1725. The transceiver 1715, or the transceiver 1715 and one or more antennas 1725, may be an example of a transmitter 1415, a transmitter 1515, a receiver 1410, a receiver 1510, or any combination thereof or component thereof, as described herein.

The memory 1730 may include random access memory (RAM) and read-only memory (ROM). The memory 1730 may store computer-readable, computer-executable code 1735 including instructions that, when executed by the processor 1740, cause the device 1705 to perform various functions described herein. The code 1735 may be stored in a non-transitory computer-readable medium such as system memory or another type of memory. In some cases, the code 1735 may not be directly executable by the processor 1740 but may cause a computer (e.g., when compiled and executed) to perform functions described herein. In some cases, the memory 1730 may contain, among other things, a basic I/O system (BIOS) which may control basic hardware or software operation such as the interaction with peripheral components or devices.

The processor 1740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1740 may be configured to operate a memory array using a memory controller. In some other cases, a memory controller may be integrated into the processor 1740. The processor 1740 may be configured to execute computer-readable instructions stored in a memory (e.g., the memory 1730) to cause the device 1705 to perform various functions (e.g., functions or tasks supporting RIS-assisted access using uplink signatures). For example, the device 1705 or a component of the device 1705 may include a processor 1740 and memory 1730 coupled with or to the processor 1740, the processor 1740 and memory 1730 configured to perform various functions described herein.

The communications manager 1720 may support wireless communication at a UE in accordance with examples as disclosed herein. For example, the communications manager 1720 may be configured as or otherwise support a means for receiving a message at the UE that is indicative that uplink communications between the UE and a network entity are via a RIS that is applying a phase-change pattern to the uplink communications to distinguish between beams used by the RIS for the uplink communications. The communications manager 1720 may be configured as or otherwise support a means for receiving a synchronization signal block from the network entity during a portion of a transmission time interval associated with transmission by the network entity of the synchronization signal block, the synchronization signal block being received as one of a set of multiple instances of the synchronization signal block reflected by the RIS, where each of the set of multiple instances of the synchronization signal block corresponds to a same synchronization signal block index. The communications manager 1720 may be configured as or otherwise support a means for transmitting a random access message during a random access occasion that corresponds to the synchronization signal block index.

By including or configuring the communications manager 1720 in accordance with examples as described herein, the device 1705 may support techniques for improvements in system efficiency such that a device may improve one or more aspects of communication (e.g., increased signal quality, increased throughput, increased transmission efficiency, increased power savings, etc.) between a UE, a RIS, and network entity, such as when an object blocks or otherwise inhibits a line-of-sight (LoS) link between the network entity and the UE. Additionally, described techniques may result in improved communication reliability, reduced latency, improved user experience related to reduced processing, reduced power consumption, more efficient utilization of communication resources, improved coordination between devices, longer battery life, improved utilization of processing capability.

In some examples, the communications manager 1720 may be configured to perform various operations (e.g., receiving, monitoring, transmitting) using or otherwise in cooperation with the transceiver 1715, the one or more antennas 1725, or any combination thereof. Although the communications manager 1720 is illustrated as a separate component, in some examples, one or more functions described with reference to the communications manager 1720 may be supported by or performed by the processor 1740, the memory 1730, the code 1735, or any combination thereof. For example, the code 1735 may include instructions executable by the processor 1740 to cause the device 1705 to perform various aspects of RIS-assisted access using uplink signatures as described herein, or the processor 1740 and the memory 1730 may be otherwise configured to perform or support such operations.

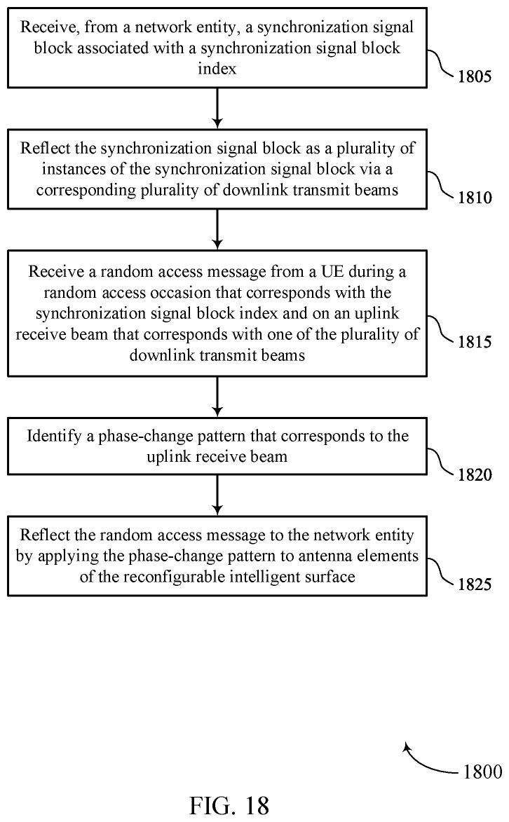

FIG. 18 shows a flowchart illustrating a method 1800 that supports RIS-assisted access using uplink signatures in accordance with aspects of the present disclosure. The operations of the method 1800 may be implemented by a RIS 150 or its components as described herein. For example, the operations of the method 1800 may be performed by a RIS 150 as described with reference to FIGS. 1 through 9. In some examples, a RIS 150 may execute a set of instructions to control the functional elements of the RIS 150 to perform the described functions. Additionally or alternatively, the RIS 150 may perform aspects of the described functions using special-purpose hardware.

At 1805, the method may include receiving, from a network entity, a synchronization signal block associated with a synchronization signal block index. The operations of 1805 may be performed in accordance with examples as disclosed herein. In some examples, aspects of the operations of 1805 may be performed by a downlink manager 825 as described with reference to FIG. 8.

At 1810, the method may include reflecting the synchronization signal block as a set of multiple instances of the synchronization signal block via a corresponding set of multiple downlink transmit beams. The operations of 1810 may be performed in accordance with examples as disclosed herein. In some examples, aspects of the operations of 1810 may be performed by an instantiation manager 830 as described with reference to FIG. 8.

At 1815, the method may include receiving a random access message from a UE during a random access occasion that corresponds with the synchronization signal block index and on an uplink receive beam that corresponds with one of the set of multiple downlink transmit beams. The operations of 1815 may be performed in accordance with examples as disclosed herein. In some examples, aspects of the operations of 1815 may be performed by an uplink manager 835 as described with reference to FIG. 8.

At 1820, the method may include identifying a phase-change pattern that corresponds to the uplink receive beam. The operations of 1820 may be performed in accordance with examples as disclosed herein. In some examples, aspects of the operations of 1820 may be performed by an identification manager 840 as described with reference to FIG. 8.

At 1825, the method may include reflecting the random access message to the network entity by applying the phase-change pattern to antenna elements of the RIS. The operations of 1825 may be performed in accordance with examples as disclosed herein. In some examples, aspects of the operations of 1825 may be performed by a watermark manager 845 as described with reference to FIG. 8.

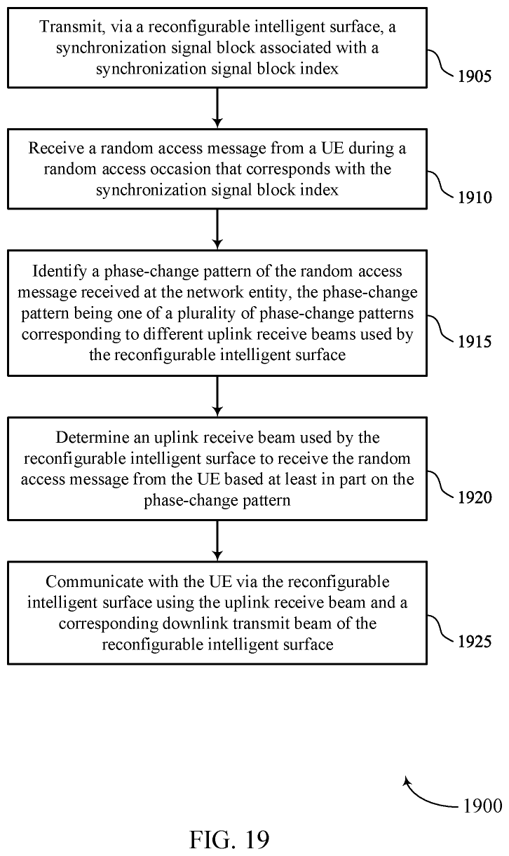

FIG. 19 shows a flowchart illustrating a method 1900 that supports RIS-assisted access using uplink signatures in accordance with aspects of the present disclosure. The operations of the method 1900 may be implemented by a network entity or its components as described herein. For example, the operations of the method 1900 may be performed by a network entity 105 as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 1905, the method may include transmitting, via a RIS, a synchronization signal block associated with a synchronization signal block index. The operations of 1905 may be performed in accordance with examples as disclosed herein. In some examples, aspects of the operations of 1905 may be performed by a signal manager 1225 as described with reference to FIG. 12.

At 1910, the method may include receiving a random access message from a UE during a random access occasion that corresponds with the synchronization signal block index. The operations of 1910 may be performed in accordance with examples as disclosed herein. In some examples, aspects of the operations of 1910 may be performed by a feedback manager 1230 as described with reference to FIG. 12.

At 1915, the method may include identifying a phase-change pattern of the random access message received at the network entity, the phase-change pattern being one of a set of multiple phase-change patterns corresponding to different uplink receive beams used by the RIS. The operations of 1915 may be performed in accordance with examples as disclosed herein. In some examples, aspects of the operations of 1915 may be performed by a pattern manager 1235 as described with reference to FIG. 12.

At 1920, the method may include determining an uplink receive beam used by the RIS to receive the random access message from the UE based on the phase-change pattern. The operations of 1920 may be performed in accordance with examples as disclosed herein. In some examples, aspects of the operations of 1920 may be performed by a determination manager 1240 as described with reference to FIG. 12.

At 1925, the method may include communicating with the UE via the RIS using the uplink receive beam and a corresponding downlink transmit beam of the RIS. The operations of 1925 may be performed in accordance with examples as disclosed herein. In some examples, aspects of the operations of 1925 may be performed by a connection manager 1245 as described with reference to FIG. 12.

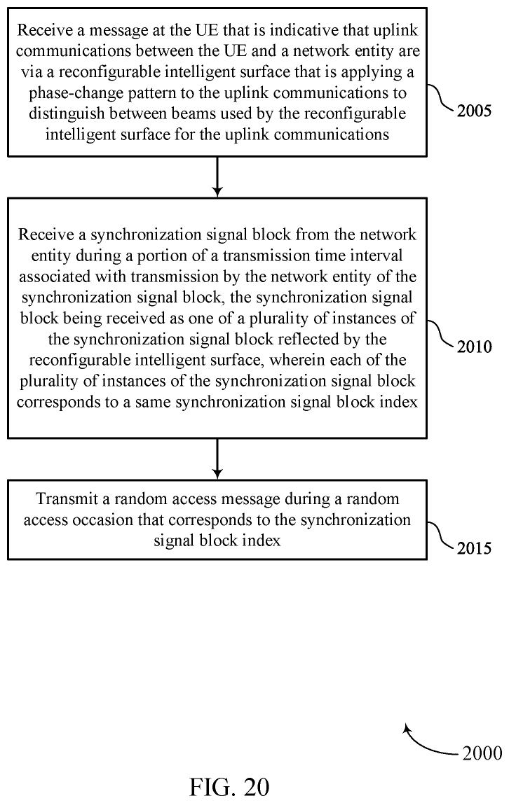

FIG. 20 shows a flowchart illustrating a method 2000 that supports RIS-assisted access using uplink signatures in accordance with aspects of the present disclosure. The operations of the method 2000 may be implemented by a UE or its components as described herein. For example, the operations of the method 2000 may be performed by a UE 115 as described with reference to FIGS. 1 through 5 and 14 through 17. In some examples, a UE may execute a set of instructions to control the functional elements of the UE to perform the described functions. Additionally or alternatively, the UE may perform aspects of the described functions using special-purpose hardware.

At 2005, the method may include receiving a message at the UE that is indicative that uplink communications between the UE and a network entity are via a RIS that is applying a phase-change pattern to the uplink communications to distinguish between beams used by the RIS for the uplink communications. The operations of 2005 may be performed in accordance with examples as disclosed herein. In some examples, aspects of the operations of 2005 may be performed by a configuration manager 1625 as described with reference to FIG. 16.

At 2010, the method may include receiving a synchronization signal block from the network entity during a portion of a transmission time interval associated with transmission by the network entity of the synchronization signal block, the synchronization signal block being received as one of a set of multiple instances of the synchronization signal block reflected by the RIS, where each of the set of multiple instances of the synchronization signal block corresponds to a same synchronization signal block index. The operations of 2010 may be performed in accordance with examples as disclosed herein. In some examples, aspects of the operations of 2010 may be performed by a synchronization manager 1630 as described with reference to FIG. 16.

At 2015, the method may include transmitting a random access message during a random access occasion that corresponds to the synchronization signal block index. The operations of 2015 may be performed in accordance with examples as disclosed herein. In some examples, aspects of the operations of 2015 may be performed by an access manager 1635 as described with reference to FIG. 16.

The following provides an overview of aspects of the present disclosure:

Aspect 1: A method for wireless communication at a reconfigurable intelligent surface, comprising: receiving, from a network entity, a synchronization signal block associated with a synchronization signal block index: reflecting the synchronization signal block as a plurality of instances of the synchronization signal block via a corresponding plurality of downlink transmit beams: receiving a random access message from a UE during a random access occasion that corresponds with the synchronization signal block index and on an uplink receive beam that corresponds with one of the plurality of downlink transmit beams: identifying a phase-change pattern that corresponds to the uplink receive beam; and reflecting the random access message to the network entity by applying the phase-change pattern to antenna elements of the reconfigurable intelligent surface.

Aspect 2: The method of aspect 1, wherein receiving the random access message from the UE during the random access occasion and on the uplink receive beam further comprises: sweeping through a plurality of uplink receive beams, the uplink receive beam on which the random access message is received being one of the plurality of uplink receive beams.

Aspect 3: The method of aspect 2, further comprising: identifying a plurality of phase-change patterns corresponding to the plurality of uplink receive beams, the phase-change pattern identified as corresponding to the uplink receive beam on which the random access message is received being one of the plurality of phase-change patterns.

Aspect 4: The method of aspect 3, wherein identifying the plurality of phase-change patterns further comprises: determining a number of the plurality of phase-change patterns, the number of the plurality of phase-change patterns based on a number of beams supported by the reconfigurable intelligent surface.

Aspect 5: The method of any of aspects 3 through 4, wherein identifying the plurality of phase-change patterns further comprises: determining the plurality of phase-change patterns based at least in part on a Hadamard matrix whose size is based on a number of beams supported by the reconfigurable intelligent surface.

Aspect 6: The method of any of aspects 3 through 5, wherein the plurality of phase-change patterns are a plurality of time-domain orthogonal cover codes.

Aspect 7: The method of any of aspects 3 through 6, wherein each of the plurality of phase-change patterns is unique from others of the plurality of phase-change patterns based on a timing of phase-changes applied to the antenna elements of the reconfigurable intelligent surface.

Aspect 8: The method of any of aspects 1 through 7, wherein reflecting the synchronization signal block further comprises: reflecting each instance of the synchronization signal block during a respective portion of a transmission time interval associated with transmission by the network entity of the synchronization signal block, the plurality of the instances of the synchronization signal block being reflected during the transmission time interval.

Aspect 9: The method of aspect 8, wherein each of the plurality of instances of the synchronization signal block corresponds to a same synchronization signal block index.

Aspect 10: A method for wireless communication at a network entity, comprising: transmitting, via a reconfigurable intelligent surface, a synchronization signal block associated with a synchronization signal block index: receiving a random access message from a UE during a random access occasion that corresponds with the synchronization signal block index: identifying a phase-change pattern of the random access message received at the network entity, the phase-change pattern being one of a plurality of phase-change patterns corresponding to different uplink receive beams used by the reconfigurable intelligent surface: determining an uplink receive beam used by the reconfigurable intelligent surface to receive the random access message from the UE based at least in part on the phase-change pattern; and communicating with the UE via the reconfigurable intelligent surface using the uplink receive beam and a corresponding downlink transmit beam of the reconfigurable intelligent surface.

Aspect 11: The method of aspect 10, further comprising: determining a number of the plurality of phase-change patterns, the number of the plurality of phase-change patterns based on a number of beams supported by the reconfigurable intelligent surface.

Aspect 12: The method of any of aspects 10 through 11, further comprising: determining the plurality of phase-change patterns based at least in part on a Hadamard matrix whose size is based on a number of beams supported by the reconfigurable intelligent surface.

Aspect 13: The method of any of aspects 10 through 12, wherein the plurality of phase-change patterns are a plurality of time-domain orthogonal cover codes.

Aspect 14: The method of any of aspects 10 through 13, wherein each of the plurality of phase-change patterns is unique from others of the plurality of phase-change patterns based on a timing of phase-changes applied to antenna elements of the reconfigurable intelligent surface.

Aspect 15: The method of any of aspects 10 through 14, further comprising: identifying a set of cyclic shifts that are permissible for use with random access message transmission, wherein the set of cyclic shifts is based at least in part on the reconfigurable intelligent surface applying the phase-change pattern to uplink communications.

Aspect 16: The method of aspect 15, further comprising: transmitting a configuration message that includes a correction term to be used by the UE in selecting the set of cyclic shifts when the reconfigurable intelligent surface is applying the phase-change pattern to the uplink communications, wherein the correction term represents a number of cyclic shifts offset.

Aspect 17: The method of aspect 16, wherein a value of the correction term is based at least in part on a number of beams associated with the reconfigurable intelligent surface.

Aspect 18: The method of any of aspects 16 through 17, further comprising: transmitting an indication that the correction term is to be applied by the UE in selecting the set of cyclic shifts.

Aspect 19: The method of aspect 18, wherein the indication comprises a one-bit field included in either a medium access control (MAC) control element (CE) or a DCI message.

Aspect 20: The method of any of aspects 18 through 19, wherein the indication further indicates a mapping between zero correlation zone configuration and the set of cyclic shifts.

Aspect 21: The method of any of aspects 16 through 20, wherein the configuration message is a radio resource control message.

Aspect 22: A method for wireless communication at a UE, comprising: receiving a message at the UE that is indicative that uplink communications between the UE and a network entity are via a reconfigurable intelligent surface that is applying a phase-change pattern to the uplink communications to distinguish between beams used by the reconfigurable intelligent surface for the uplink communications; receiving a synchronization signal block from the network entity during a portion of a transmission time interval associated with transmission by the network entity of the synchronization signal block, the synchronization signal block being received as one of a plurality of instances of the synchronization signal block reflected by the reconfigurable intelligent surface, wherein each of the plurality of instances of the synchronization signal block corresponds to a same synchronization signal block index; and transmitting a random access message during a random access occasion that corresponds to the synchronization signal block index.

Aspect 23: The method of aspect 22, further comprising: selecting a set of cyclic shifts that are permissible for application to transmission of the random access message, wherein selection of the set of cyclic shifts is based at least in part on the reconfigurable intelligent surface applying the phase-change pattern to the uplink communications.

Aspect 24: The method of aspect 23, wherein selecting the set of cyclic shifts further comprises: receiving a configuration message that includes a correction term to be used in selecting the set of cyclic shifts when the reconfigurable intelligent surface is applying the phase-change pattern to the uplink communications, wherein the correction term represents a number of cyclic shifts offset.

Aspect 25: The method of aspect 24, wherein a value of the correction term is based at least in part on a number of beams associated with the reconfigurable intelligent surface.

Aspect 26: The method of any of aspects 24 through 25, wherein selecting the set of cyclic shifts further comprises: receiving an indication that the correction term is to be applied in selecting the set of cyclic shifts.

Aspect 27: The method of aspect 26, wherein the indication comprises a one-bit field included in either a medium access control (MAC) control element (CE) or a DCI message.

Aspect 28: The method of any of aspects 26 through 27, wherein the indication further indicates a mapping between zero correlation zone configuration and the set of cyclic shifts.

Aspect 29: The method of any of aspects 24 through 28, wherein the configuration message is a radio resource control message.

Aspect 30: An apparatus for wireless communication at a reconfigurable intelligent surface, comprising a processor; memory coupled with the processor; and instructions stored in the memory and executable by the processor to cause the apparatus to perform a method of any of aspects 1 through 9.

Aspect 31: An apparatus for wireless communication at a reconfigurable intelligent surface, comprising at least one means for performing a method of any of aspects 1 through 9.

Aspect 32: A non-transitory computer-readable medium storing code for wireless communication at a reconfigurable intelligent surface, the code comprising instructions executable by a processor to perform a method of any of aspects 1 through 9.

Aspect 33: An apparatus for wireless communication at a network entity, comprising a processor; memory coupled with the processor; and instructions stored in the memory and executable by the processor to cause the apparatus to perform a method of any of aspects 10 through 21.

Aspect 34: An apparatus for wireless communication at a network entity, comprising at least one means for performing a method of any of aspects 10 through 21.

Aspect 35: A non-transitory computer-readable medium storing code for wireless communication at a network entity, the code comprising instructions executable by a processor to perform a method of any of aspects 10 through 21.

Aspect 36: An apparatus for wireless communication at a UE, comprising a processor: memory coupled with the processor; and instructions stored in the memory and executable by the processor to cause the apparatus to perform a method of any of aspects 22 through 29.

Aspect 37: An apparatus for wireless communication at a UE, comprising at least one means for performing a method of any of aspects 22 through 29.

Aspect 38: A non-transitory computer-readable medium storing code for wireless communication at a UE, the code comprising instructions executable by a processor to perform a method of any of aspects 22 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a reconfigurable intelligent surface, comprising:
receiving, from a network entity, a synchronization signal block associated with a synchronization signal block index;
reflecting the synchronization signal block as a plurality of instances of the synchronization signal block via a corresponding plurality of downlink transmit beams;
receiving a random access message from a user equipment (UE) during a random access occasion that corresponds with the synchronization signal block index and on an uplink receive beam that corresponds with one of the plurality of downlink transmit beams;
identifying a phase-change pattern that corresponds to the uplink receive beam; and
reflecting the random access message to the network entity by applying the phase-change pattern to antenna elements of the reconfigurable intelligent surface.

2. The method of claim 1, wherein receiving the random access message from the UE during the random access occasion and on the uplink receive beam further comprises:
sweeping through a plurality of uplink receive beams, the uplink receive beam on which the random access message is received being one of the plurality of uplink receive beams.

3. The method of claim 2, further comprising:
identifying a plurality of phase-change patterns corresponding to the plurality of uplink receive beams, the phase-change pattern identified as corresponding to the uplink receive beam on which the random access message is received being one of the plurality of phase-change patterns.

4. The method of claim 3, wherein identifying the plurality of phase-change patterns further comprises:
determining a number of the plurality of phase-change patterns, the number of the plurality of phase-change patterns based on a number of beams supported by the reconfigurable intelligent surface.

5. The method of claim 3, wherein identifying the plurality of phase-change patterns further comprises:
determining the plurality of phase-change patterns based at least in part on a Hadamard matrix whose size is based on a number of beams supported by the reconfigurable intelligent surface.

6. The method of claim 3, wherein the plurality of phase-change patterns are a plurality of time-domain orthogonal cover codes.

7. The method of claim 3, wherein each of the plurality of phase-change patterns is unique from others of the plurality of phase-change patterns based on a timing of phase-changes applied to the antenna elements of the reconfigurable intelligent surface.

8. The method of claim 1, wherein reflecting the synchronization signal block further comprises:
reflecting each instance of the synchronization signal block during a respective portion of a transmission time interval associated with transmission by the network entity of the synchronization signal block, the plurality of the instances of the synchronization signal block being reflected during the transmission time interval.

9. The method of claim 8, wherein each of the plurality of instances of the synchronization signal block corresponds to a same synchronization signal block index.

10. An apparatus for wireless communication at a reconfigurable intelligent surface, comprising:
a processor;
memory coupled with the processor; and
instructions stored in the memory and executable by the processor to cause the apparatus to:
transmit, via a reconfigurable intelligent surface, a synchronization signal block associated with a synchronization signal block index;
receive a random access message from a user equipment (UE) during a random access occasion that corresponds with the synchronization signal block index:
identify a phase-change pattern of the random access message received at the network entity, the phase-change pattern being one of a plurality of phase-change patterns corresponding to different uplink receive beams used by the reconfigurable intelligent surface;
determine an uplink receive beam used by the reconfigurable intelligent surface to receive the random access message from the UE based at least in part on the phase-change pattern; and
communicate with the UE via the reconfigurable intelligent surface using the uplink receive beam and a corresponding downlink transmit beam of the reconfigurable intelligent surface.

11. The apparatus of claim 10, wherein the instructions are further executable by the processor to cause the apparatus to:
determine a number of the plurality of phase-change patterns, the number of the plurality of phase-change patterns based on a number of beams supported by the reconfigurable intelligent surface.

12. The apparatus of claim 10, wherein the instructions are further executable by the processor to cause the apparatus to:
determine the plurality of phase-change patterns based at least in part on a Hadamard matrix whose size is based on a number of beams supported by the reconfigurable intelligent surface.

13. The apparatus of claim 10, wherein the plurality of phase-change patterns are a plurality of time-domain orthogonal cover codes.

14. The apparatus of claim 10, wherein each of the plurality of phase-change patterns is unique from others of the plurality of phase-change patterns based on a timing of phase-changes applied to antenna elements of the reconfigurable intelligent surface.

15. The apparatus of claim 10, wherein the instructions are further executable by the processor to cause the apparatus to:
identify a set of cyclic shifts that are permissible for use with random access message transmission, wherein the set of cyclic shifts is based at least in part on the reconfigurable intelligent surface applying the phase-change pattern to uplink communications.

16. The apparatus of claim 15, wherein the instructions are further executable by the processor to cause the apparatus to:
transmit a configuration message that includes a correction term to be used by the UE in selecting the set of cyclic shifts when the reconfigurable intelligent surface is applying the phase-change pattern to the uplink communications, wherein the correction term represents a number of cyclic shifts offset.

17. The apparatus of claim 16, wherein a value of the correction term is based at least in part on a number of beams associated with the reconfigurable intelligent surface.

18. The apparatus of claim 16, wherein the instructions are further executable by the processor to cause the apparatus to:
transmit an indication that the correction term is to be applied by the UE in selecting the set of cyclic shifts.

19. The apparatus of claim 18, wherein the indication comprises a one-bit field included in either a medium access control (MAC) control element (CE) or a downlink control information (DCI) message, and wherein the indication further indicates a mapping between zero correlation zone configuration and the set of cyclic shifts.

20. An apparatus for wireless communication, comprising:
a processor;
memory coupled with the processor; and
instructions stored in the memory and executable by the processor to cause the apparatus to:
receive a message at the UE that is indicative that uplink communications between the UE and a network entity are via a reconfigurable intelligent surface that is applying a phase-change pattern to the uplink communications to distinguish between beams used by the reconfigurable intelligent surface for the uplink communications;
receive a synchronization signal block from the network entity during a portion of a transmission time interval associated with transmission by the network entity of the synchronization signal block, the synchronization signal block being received as one of a plurality of instances of the synchronization signal block reflected by the reconfigurable intelligent surface, wherein each of the plurality of instances of the synchronization signal block corresponds to a same synchronization signal block index; and
transmit a random access message during a random access occasion that corresponds to the synchronization signal block index.

21. The apparatus of claim 20, wherein the instructions are further executable by the processor to cause the apparatus to:
select a set of cyclic shifts that are permissible for application to transmission of the random access message, wherein selection of the set of cyclic shifts is based at least in part on the reconfigurable intelligent surface applying the phase-change pattern to the uplink communications.

22. The apparatus of claim 21, wherein the instructions executable by the processor to cause the apparatus to select the set of cyclic shifts are further executable by the processor to cause the apparatus to:
receive a configuration message that includes a correction term to be used in selecting the set of cyclic shifts when the reconfigurable intelligent surface is applying the phase-change pattern to the uplink communications, wherein the correction term represents a number of cyclic shifts offset.

23. The apparatus of claim 22, wherein a value of the correction term is based at least in part on a number of beams associated with the reconfigurable intelligent surface.

24. The apparatus of claim 22, wherein the instructions executable by the processor to cause the apparatus to select the set of cyclic shifts are further executable by the processor to cause the apparatus to:
receive an indication that the correction term is to be applied in selecting the set of cyclic shifts.

25. The apparatus of claim 24, wherein the indication comprises a one-bit field included in either a medium access control (MAC) control element (CE) or a downlink control information (DCI) message.

26. The apparatus of claim 24, wherein the indication further indicates a mapping between zero correlation zone configuration and the set of cyclic shifts.

27. The apparatus of claim 22, wherein the configuration message is a radio resource control message.

28. An apparatus for wireless communication at a reconfigurable intelligent surface, comprising:
a processor;
memory coupled with the processor; and
instructions stored in the memory and executable by the processor to cause the apparatus to:
receive, from a network entity, a synchronization signal block associated with a synchronization signal block index;
reflect the synchronization signal block as a plurality of instances of the synchronization signal block via a corresponding plurality of downlink transmit beams;
receive a random access message from a user equipment (UE) during a random access occasion that corresponds with the synchronization signal block index and on an uplink receive beam that corresponds with one of the plurality of downlink transmit beams;
identify a phase-change pattern that corresponds to the uplink receive beam; and
reflect the random access message to the network entity by applying the phase-change pattern to antenna elements of the reconfigurable intelligent surface.

29. The apparatus of claim 28, wherein the instructions executable by the processor to cause the apparatus to receive the random access message from the UE during the random access occasion and on the uplink receive beam are further executable by the processor to cause the apparatus to:
sweep through a plurality of uplink receive beams, the uplink receive beam on which the random access message is received being one of the plurality of uplink receive beams.

30. The apparatus of claim 29, wherein the instructions are further executable by the processor to cause the apparatus to:
identify a plurality of phase-change patterns corresponding to the plurality of uplink receive beams, the phase-change pattern identified as corresponding to the uplink receive beam on which the random access message is received being one of the plurality of phase-change patterns.
